(19) United States
(12) Patent Application Publication
(10) Pub. No.: US 2025/0292708 A1
(43) Pub. Date: Sep. 18, 2025

(54) HYBRID HEAT TRANSFER LABEL ASSEMBLIES

(71) Applicant: Illinois Tool Works Inc., Glenview, IL (US)

(72) Inventors: Lee R.B. Dixon, Newcastle Upon Tyne (GB); Carlos Altamirano, East Hartford, CT (US); Luigi Filippino, Padova (IT); Michael B. Colella, Southington, CT (US); Trinh Truong, Manchester, CT (US); Emma Bleszinski, Hartford, CT (US)

(73) Assignee: Illinois Tool Works Inc., Glenview, IL (US)

(21) Appl. No.: 19/222,216

(22) Filed: May 29, 2025

Related U.S. Application Data
(63) Continuation of application No. 19/186,209, filed on Apr. 22, 2025.
Application No. 19/186,209 is a continuation-in-part of application No. 18/017,286, filed on Jan. 20, 2023, now Pat. No. 12,307,925.
(60) Provisional application No. 63/059,421, filed on Jul. 31, 2020.

(51) Int. Cl. G09F 3/10; G09F 3/02

(52) U.S. Cl. CPC G09F 3/10; G09F 3/02; G09F 2003/0202; G09F 2003/025; G09F 2003/0257

(57) ABSTRACT

Methods for applying hybrid heat transfer labels to an article are provided. The methods includes non-digitally printing a protective layer onto a carrier layer, digitally printing a graphics layer, non-digitally printing a backer layer, and printing an adhesive. The adhesive and the protective layer can be printed to overlap such that the adhesive and the protective layer bond with each other via chemical-physical interactions upon application of heat and pressure to the protective layer. Additionally, a hybrid heat transfer label assembly is provided that includes a plastic carrier layer, a non-digitally printed protective layer, a digitally printed layer disposed with the non-digitally printed protective layer between the digitally printed layer and the plastic carrier layer, and a non-digitally printed second layer disposed with the digitally printed layer between the non-digitally printed protective layer and the non-digitally printed second layer. The non-digitally printed second layer includes a rubber layer.

### CROSS-REFERENCE TO RELATED APPLICATIONS

This application is a continuation of U.S. patent application Ser. No. 19/186,209 (filed 22 Apr. 2025), which is a continuation-in-part of U.S. patent application Ser. No. 18/017,286 (filed 20 Jan. 2023), which is a national stage entry of International Patent Application No. PCT/US2021/043599 (filed 29 Jul. 2021), which claims priority to U.S. Provisional Patent Application No. 63/059,421 (filed 31 Jul. 2020). The entire disclosures of these applications are incorporated herein by reference.

### BACKGROUND

### Technical Field

The subject matter described herein relates to labels that can be transferred to surfaces using the application of heat or a combination of heat and pressure.

### Discussion of Art

Labels having indicia and/or graphics are used in the garment industry to decorate clothing articles and/or to mark the articles (e.g., to identify the manufacture, size, washing instructions, etc.). These labels may be used with durable goods as well.

Heat transfer labels including graphics and/or markings may be made using screen printing, flexographic printing, gravure printing, or rotogravure priming processes. These printing processes use ink and heat activated adhesive systems that can provide necessary properties for heat transfer labels, such as adhesion to a target article, and other chemical and environmental resistance properties.

Digital printing can provide superior quality graphics than the above printing processes with tight tolerances, fine details, and multi-color capabilities. Further, digital printing can allow for variable data to be easily printed onto articles (e.g., personalized information that is different for different articles), as digital printing does not require pre-fabricated printing plates.

Some heat transfer labels are hybrid labels that combine non-digital printing processes (e.g., screen printing, flexographic printing, or rotogravure priming processes) and digital printing processes to create the labels. These labels may have a carrier layer with a digitally printed layer (e.g., images and/or indicia) on the carrier layer, a polymeric coating layer on the digitally printed layer, and adhesive(s) on the coating layer. The coating layer and/or adhesive(s) can be printed using a non-digital printing process, while an image and/or indicia in the digitally printed layer may be printed using a digital printer. The label can be transferred to an article (e.g., a garment) by placing the adhesive against the article and applying heat or heat and pressure to separate the digitally printed layer and the protective layer from the carrier layer. The adhesive secures the digitally printed layer and the coating layer to the article.

For example, one known heat transfer label may include a carrier paper formed by paper coated with silicone, a screen printed protective coating on the carrier paper (e.g., formed from Estane 5703 polyurethane/cellulose ester resin blend), a barcode printed on the protective coating (e.g., a black-and-white RICOH variable barcode printed using polyester dry toner resin), two screen printed backup layers on the barcode (e.g., two layers of Estane 5703 polyurethane/cellulose ester resin blend that forms white layers), and three layers of screen printed adhesive layers on the screen print backup layers (e.g., formed from a co-polyamide/polyurethane resin dispersion blend).

One issue with these types of hybrid labels is that the digitally printed layer may be susceptible to damage or other effects after transfer to the article. This can deteriorate the appearance of the image and/or indicia. Another issue with these types of hybrid labels is that dyes within the article may seep into the label and interfere with the appearance of the image and/or indicia.

### BRIEF DESCRIPTION

In one example, a method for applying a hybrid heat transfer label to an article from a hybrid heat transfer label assembly is provided. The method includes non-digitally printing a protective layer onto a carrier layer, digitally printing a graphics layer onto the protective layer, non-digitally printing a backer layer onto the graphics layer, and printing an adhesive onto the backer layer. The adhesive and the protective layer are printed to overlap such that the adhesive and the protective layer bond with each other via chemical-physical interactions upon application of heat and pressure to the protective layer. The adhesive and protective layer are printed to bond with each other using the chemical-physical interactions such that the protective layer tears and separates the hybrid heat transfer label from the carrier layer and a remainder of the hybrid heat transfer label assembly in areas where the adhesive and the protective layer overlap each other to apply the hybrid heat transfer label to the article.

In another example, a method for applying a hybrid heat transfer label to an article from a hybrid heat transfer label assembly is provided. The method includes non-digitally printing a protective layer onto a carrier layer, digitally printing a graphics layer onto the protective layer, non-digitally printing a backer layer onto the graphics layer, printing an adhesive onto the backer layer, and bonding the protective layer to the adhesive using chemical-physical interactions and applying the hybrid heat transfer label to the article by applying heat and pressure to the carrier layer with a heated die.

In another example, a hybrid heat transfer label assembly is provided. The label assembly includes a plastic carrier layer, a non-digitally printed protective layer, a digitally printed layer disposed with the non-digitally printed protective layer between the digitally printed layer and the plastic carrier layer, and a non-digitally printed second layer disposed with the digitally printed layer between the non-digitally printed protective layer and the non-digitally printed second layer. The non-digitally printed protective layer, the digitally printed layer, and the non-digitally printed second layer form a hybrid heat transfer label that is configured to separate from the plastic carrier layer and adhere to an article upon application of heat to the plastic carrier layer. The non-digitally printed second layer includes a rubber layer.

### BRIEF DESCRIPTION OF THE DRAWINGS

The inventive subject matter may be understood from reading the following description of non-limiting embodiments, with reference to the attached drawings, wherein below:

FIG. 1 illustrates one example of a hybrid heat transfer label assembly;

FIG. 2 illustrates application of the label assembly shown in FIG. 1 to an article;

FIG. 3 also illustrates application of the label assembly shown in FIG. 1 to the article shown in FIG. 2;

FIG. 4 illustrates one example of a hybrid heat transfer label assembly;

FIG. 5 illustrates another example of a hybrid heat transfer label assembly;

FIG. 6 illustrates another example of a hybrid heat transfer label assembly;

FIG. 7 illustrates another example of a hybrid heat transfer label assembly;

FIG. 8 illustrates another example of a hybrid heat transfer label assembly;

FIG. 9 illustrates another example of a hybrid heat transfer label assembly;

FIG. 10 illustrates another example of a hybrid heat transfer label assembly;

FIG. 11 illustrates another example of a hybrid heat transfer label assembly;

FIG. 12 illustrates another example of a hybrid heat transfer label assembly;

FIG. 13 illustrates one example of an in-line printing system that can be used to create one or more of the hybrid digital heat transfer label assemblies described herein;

FIG. 14 illustrates another example of a printing system that can be used to create one or more of the hybrid digital heat transfer label assemblies described herein;

FIG. 15 illustrates another example of a hybrid heat transfer label assembly;

FIG. 16 illustrates one example of a method for constructing and/or applying the label shown in FIG. 15 to an article;

FIG. 17 illustrates another example of a hybrid heat transfer label assembly;

FIG. 18 illustrates one example of a method for constructing and/or applying the label shown in FIG. 17 to the article;

FIG. 19 illustrates another example of a hybrid heat transfer label assembly;

FIG. 20 illustrates another example of a hybrid heat transfer label assembly;

FIG. 21 illustrates another example of a hybrid heat transfer label assembly;

FIG. 22 illustrates another example of a hybrid heat transfer label assembly;

FIG. 23 illustrates another example of a hybrid heat transfer label assembly;

FIG. 24 illustrates another example of a hybrid heat transfer label assembly; and

FIG. 25 illustrates another example of a hybrid heat transfer label assembly.

### DETAILED DESCRIPTION

The inventive subject matter described herein provides hybrid heat transfer label assemblies and methods for manufacturing and applying the same. The label assemblies combine both digital and non-digital printing processes to provide the label assemblies that can be applied to a wide variety of surfaces while having the benefits of digital printing and non-digital printing. For example, with respect to digital printing part of the label assemblies, the images and/or indicia that are digitally printed can be higher quality, higher resolution, and more photorealistic than the same images and/or indicia printed using non-digital printing. The digitally printed images and/or indicia can be printed using a wide variety of colors, including (but not limited to) cyan, magenta, yellow, black, white, invisible (or translucent), taggant, spot colors, metallic colors, foils, fluorescents, clear matte, and gloss inks. These images and/or indicia can be printed in a single pass through a digital printer. This reduces re-insertions of the label assemblies when compared to some known printing methods. This also provides more reliable registration between colors that are digitally printed.

Digital printing also provides the ability to incorporate variable data, such as images and/or indicia that are different for each or at least several label assemblies. Variable designs, embellishments, effects, variable barcodes (e.g., 1D or 2D barcodes), quick response (QR) codes, sequential numbering, etc., can be digitally printed all in one pass through the digital printer.

Digital printing also provides the ability to incorporate security features into the label assemblies. These security features can include watermarks (which may be invisible to the naked or unmagnified eye), marks that are detectable by a scanner or mobile device, etc. These watermarks also or alternatively can be used to provide consumer engagement, brand authenticity, and track and trace functionality using marks that are almost imperceptible to the naked and unmagnified human eye. Invisible ultraviolet (UV) ink can be digitally printed into the label assemblies to provide covert identification, sequential numbering, and other variable data design. This type of ink can then be seen by exposing the label assembly using UV light. Machine taggant inks, magnetic inks, or other inks can be digitally printed into the label assemblies. These inks can be electronically detected and authenticated by handheld scanner. Additionally, other inks providing special effects, gloss, matte, foiling, embossing, etc. can be done in the label assembly on the same single printing pass on digital printer which further reduces the need for additional conventional screen print passes to create the desired effect. Using digital printing to provide some or all these inks can simplify the manufacturing process of the label assemblies by reducing the number of printing passes (e.g., the number of times that ink is applied to the same footprint or area above a carrier layer), time, and materials otherwise needed to create the same label assembly but using only non-digital printing processes.

The hybrid label assembly also obtains the benefits of the digital printing processes described above, as well as benefits provided by non-digital printing. The security features described herein optionally can be printed using one or more of the non-digital printing processes or techniques described herein. For example one or more layers in the assembly can be screen printed, which provides highly opaque back up layers (e.g., layers that are behind the digitally printed images and/or indicia when the label assembly is adhered to a garment), the addition of hard to match spot colors, extended gamut colors (or other colors that are not possible to obtain via digital printing), and the incorporation of metallic inks and the non-digitally printed security features described above. Additionally, the non-digital printing of one or more layers of the label assembly allows for the incorporation of different tie coat and/or adhesive layers for adhesion to a wide range of substrates (e.g., surfaces of articles), such as plastics (e.g., polyester, copolyester, polypropylene cosmetic containers and toothbrush handles; ABS, SAN, PS, and HIPS razor handles and appliance components; PVC for automotive visor labels, etc.); fabrics used for automotive visor labels and seat belt labels; engineering resins (e.g., polycarbonate, nylon and various blends); metal and painted metal appliance components and sports equipment; painted graphite sports equipment; glass; and rubber used for belts, hoses, tires, etc. The non-digitally printed layers can provide for improved durability of the underlying digitally printed images and/or indicia, such as scratch and abrasion resistance due to thicker deposits, as well as improved chemical resistance and durability through incorporation of a first down protective layer (e.g., a layer that is deposited between the carrier layer and the digitally printed layer, as described below).

A heat transfer label for application to various substrates includes a carrier (usually in the form of a roll-to-roll web or cut down into sheets), a release coat applied to the carrier, an optional protective layer applied to the release coat, and a composition including a digitally printed graphic design, a screen printed back-up layer(s) applied to the digitally printed graphic design, and an adhesive applied either directly to the digitally printed graphic design or to the screen printed back up layers. Depending upon the digital print engine, a tie layer may be screen printed between the digitally printed graphic design and any subsequent screen-printed layers. The digitally printed design and screen-printed layers are printed and cured to form a storable film on the carrier web. Some examples of screen printable inks suitable for use in this invention include solvent-based inks, water-based inks, UV curable inks as well as 100% solids inks as described by Downs et. al. U.S. Pat. No. 5,919,834 and Penrose et. al. US2019/0378438 A1. The composition is heat transferred to the substrate and the carrier web is removed. A method for making the label and a method for marking an item are also disclosed.

Hybrid heat transfer labels made using a combination of digital printing and at least one other conventional printing method, such as screen printing, are provided according to various embodiments. The hybrid heat transfer labels include a heat activated adhesive layer and an optional protective layer, which are printed via screen, flexographic, rotogravure, or pad printing method to provide excellent adhesion to a target article and good chemical and other environmental resistance. Further, the hybrid heat transfer labels include a digitally printed layer offering superior quality graphic images and markings that can be customized quickly and easily to provide cost effective specialty heat transfer labels.

The label assemblies described herein can be hybrid digital and screen-printed heat transfer labels for application to a variety of surfaces, such as plastics, metals, glass, automotive fabrics and rubber compounds, fabrics for outdoor sporting and safety equipment, fabrics for medical use applications, and the like. One or more of the printers used to generate the label assemblies can include printers such as the HP INDIGO Liquid Electrophotographic digital offset presses, ‘solid’ or ‘dry toner’ printers or presses, water based pigment dye, sublimation or latex inkjet printers and presses, UV curable inkjet printheads and presses, vegetable or mineral oil based direct imaging offset lithographic or flexographic presses, etc.

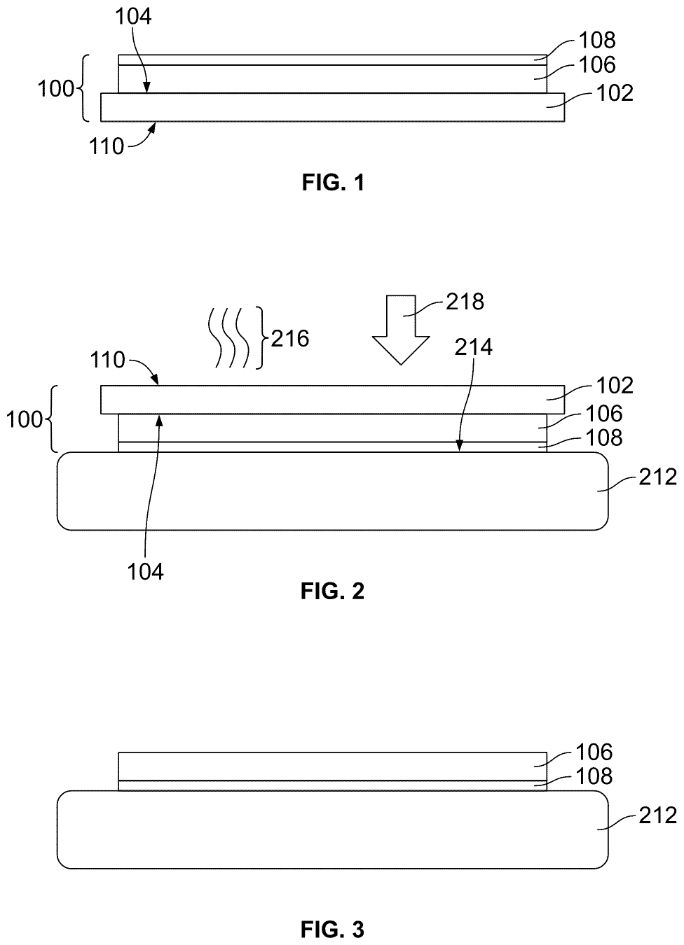

FIG. 1 illustrates one example of a hybrid heat transfer label assembly 100. The assemblies shown in the Figures are not necessarily drawn to scale. One or more layers in the assemblies may be thicker or thinner than one or more other layers, even though the relative thickness of the layers shown in the Figures may show a different relative thickness. Stated differently, a first layer that is shown in a Figure as being thinner than a second layer may actually be thicker than the second layer.

The label assembly 100 includes a carrier layer 102 having an upper surface 104 that supports a multi-layered label 106 and an adhesive 108. As described herein, the multi-layered label 106 is formed on the upper surface 104 of the carrier layer 102 from several layers with at least one layer being digitally printed (e.g., by one or more digital printers in one or more passes) and at least one layer being non-digitally printed (e.g., screen printed, flexographic printed, gravure printed, rotogravure printed, pad printed, etc.).

The carrier layer 102 can be formed from a paper or plastic film. Suitable materials for the carrier layer 102 include polypropylene film as well as polyester films, with polyester being more heat resistant. MYLAR® and MELINEX® are two trademarks under which these materials are commercially available. The carrier film 102 alternatively may be formed from polyethylene terephthalate (PET) film. Paper is less costly than plastic films, however, the dimensional stability of paper is less desirable unless printing is conducted in a controlled environment with regard to temperature and relative humidity. The carrier layer 102 can be a release coated paper or plastic film. The release coating can be silicone based, or the release coating can include other coatings. In one embodiment, both surfaces 104, 110 of the carrier layer 102 are coated with release coatings, in which the release coatings have different release characteristics. For example, the printed surface 104 will generally have a tighter release than the non-printed surface 110, alternatively it could be the same release value to help prevent curling issues, or it could be on the print surface 104 only.

The adhesive 108 may be non-digitally printed onto the multi-layered label 106 or may be applied to the multi-layered label 106 as a powder or printable adhesive. For an example, the adhesive 108 may be applied to the multi-layered label 106 as a powder while an upper surface or layer on which the powder adhesive 108 is applied is wet. The adhesive 108 may be a heat activated adhesive, such as one or more powdered resins including polyamide, polyester, and polyurethane. Examples of polyamide resins include GRILTEX® IA and other polyamides from EMS-GRILTECH, a unit of EMS-CHEMIE, as well as UNEX®PA T11 and other polyamides from DAKOTA COATINGS N.V. Examples of polyester resins include GRILTEX® 6E and other polyesters from EMS-GRILTECH and UNEX®PES T6 and other polyesters from DAKOTA COATING N.V. Examples of polyurethane resins include UNEX® 4529 and other polyurethanes from DAKOTA COATINGS N.V. If applied as a powder, the adhesive powder resin can be dispersed in a resin solution, solvent, or water prior to application to create a printable adhesive.

The adhesive 108 may also be a non-digitally printed adhesive based on a combination of one or more rosin and/or one or more resins. These can be solvent-borne, water-borne or UV-curable. These can be heat-activated combinations of polyolefins, polyesters, polyacrylics, polyvinyl chloride/polyvinyl acetate (PVC/PVA) resins and terpene-based rosins. Examples of polyolefin-type resins can be ADVANTIS 510W, CP343 or others provided by Eastman Chemical Company as well as LICOCENE PP2602, LICOCENE PP MA4221 or others provided by Clariant Plastics & Coatings Ltd., a unit of Clariant International. Examples of polyesters can be AROPLAZ® 4097-WG4-55, FINE-TONE® T-6694 or others provided by Reichold, LLC as well as VITEL 2200B, VITEL 3300B or others provided by Bostik, Inc. Examples of polyacrylics can be PARALOID® B-48N or others provided by Dow Coating Materials, a division of Dow Chemical Corporation. PVC/PVA resins can be VINNOL® E 22/48A, VINNOL® H 15/50 of others provided by Wacker Chemie AG. Examples of terpene rosins include SYLVARES® 1095, SYLVARES® TR7125 or others from Kraton Corporation as well as STABELITE™ ESTER 10-E, LEWISOL™ 28-M and others from Eastman Chemical Company. These can be blended in varying percentages in solvent, water and/or liquid monomer prior to application to create a printable adhesive.

FIGS. 2 and 3 illustrate the application of the label assembly 100 shown in FIG. 1 to an article 212. The article 212 can represent an object to which the multi-layered label 106 is to be affixed, such as a garment, plastics such as a cosmetic or personal care object or container, a medical fabric, a sports fabric, a safety fabric, an automotive fabric, a rubber object, a vulcanized rubber object, a metal object, a fibrous object, a glass object, etc. The label assembly 100 is positioned onto the article 212 so that the adhesive 108 contacts a surface 214 of the article 212. Heat 216 or a combination of heat 216 and pressure 218 can be applied onto the non-printed surface 110 of the carrier layer 102 that is opposite the printed surface 104 of the carrier layer 102. As shown, the label assembly 100 may be flipped over relative to the perspective in FIG. 1 when applied to the article 212. The heat 216 or heat 216 and pressure 218 can cause the multi-layered label 106 to separate from the release coating of or on the carrier layer 102 and for the adhesive 108 to couple the multi-layered label 106 to the article 212.

For example, when the heat 216 or heat 216 and pressure 218 are applied, the adhesive 108 may soften and permanently adhere to the article 212. Since the adhesion strengths between the layers of the multi-layered label 106 are greater than that between the multi-layered label 106 and the carrier layer 102, the layers of the multi-layered label 106 remain attached to each other and transfer together to the article 212 upon application of the heat 216 or heat 216 and pressure 218, as shown in FIG. 3. After this heat transfer process, the carrier layer 102 is peeled off or otherwise removed from the multi-layered label 106 and the multi-layered label 106 is permanently attached to the article 212 via the adhesive 108, as shown in FIG. 3.

Each of the non-digitally printed layers and digitally printed layers described herein can be formed from a single printing pass or multiple printing passes. For example, any of the layers can be formed by a single pass of a digital printer or non-digital printer over the underlying layer(s), or can be formed by several successive printing passes (e.g., as multiple layers printed directly onto each other in the successive printing passes).

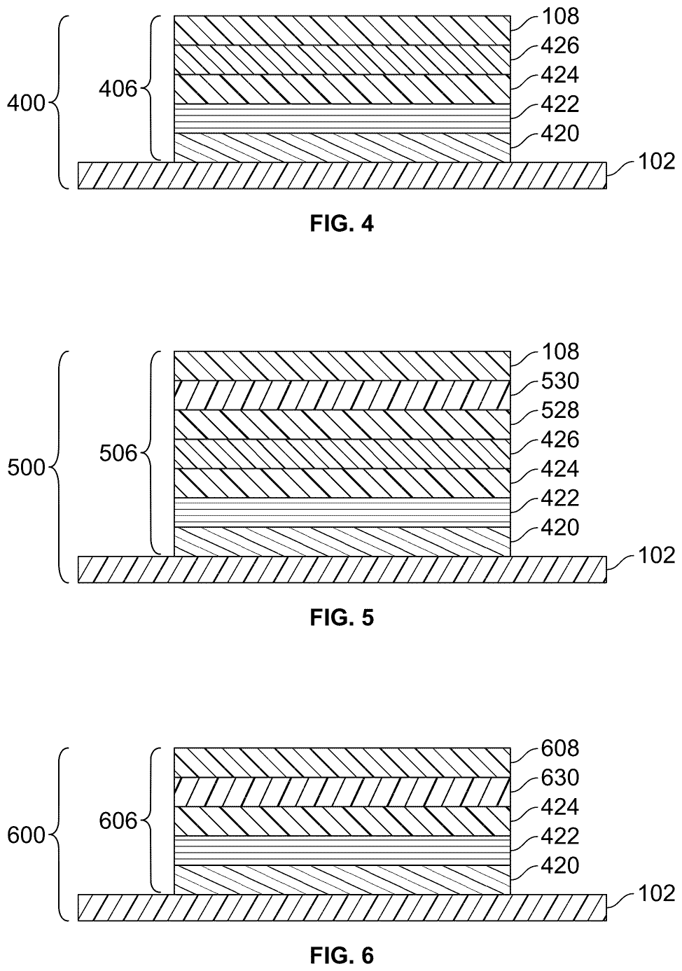

FIG. 4 illustrates one example of a hybrid heat transfer label assembly 400. The label assembly 400 can represent the label assembly 100 shown in FIGS. 1 and 2, and includes a multi-layered label 406 that can represent the multi-layered label 106 shown in FIGS. 1 through 3. The multi-layered label 406 can be formed (e.g., printed) onto the carrier layer 102 described above. The multi-layered label 406 includes a coated protective layer 420 that can be non-digitally printed directly onto the carrier layer 102. Optionally, part or all the protective layer 420 can be digitally printed onto the carrier layer 102. The protective layer 420 can be referred to as the first down layer. The protective layer 420 can be clear, translucent, light-transmissive, etc., so that one or more of the layers printed onto the protective layer 420 are visible through the protective layer 420 after the multi-layered label 406 is adhered to the article 212. The protective layer 420 can be formed from polymer material through which the one or more of the layers printed onto the protective layer 420 are visible.

For example, the protective layer 420 can be printed from a composition comprising about 82.6% by weight Estane®5703 resin solution (comprised of about 20% polyester type thermoplastic polyurethane in a cyclohexanone/ethyl 3-ethoxypropionate mixture) (Lubrizol Advanced materials, Inc.), about 9.9% CAB-381-20 resin solution (comprised of about 20% cellulose acetate butyrate in a cyclohexanone/ethyl 3-ethoxypropionate mixture) (Eastman Chemical Company), about 5% cyclohexanone (Ashland Inc.), about 2% Cab-O-Sil® TS-610 fumed silica (Cabot Corp), and about 0.5% TEGO® Foamex-N defoamer (Evonik industries AG). The above composition contains about 20.5%, by weight, solids and about 79.5%, by weight, VOCs. Optionally, the protective top clear can contain any of several crosslinking agents to improve the toughness and chemical resistance of the protective top clear, e.g. 5% of Desmodur® N-75 aliphatic polyisocyanate (Bayer Material Science). The term “about” includes the value stated above, as well as other values within manufacturing tolerances (e.g., within a 1% range, within a 2% range, or within a 3% range in different embodiments).

A surface treatment layer 422 can be printed onto the protective layer 420. The surface treatment layer 422 can be printed using a non-digital printing process described herein. Alternatively, part or all the surface treatment layer 422 can be digitally printed. The surface treatment layer 422 can be formed from one or more primers or coatings to provide a surface on which a digitally printed layer 424 can be digitally printed. For example, the protective layer 420 may be too smooth for the digital printer (e.g., an ink jet printer) to digitally print the digitally printed layer 424 directly onto the protective layer 420. The surface treatment layer 422 may provide a less smooth surface that is more receptive to the digitally printed inks of the digitally printed layer 424 (e.g., a higher or lower surface energy to prevent unintended smearing, beading or blending of the digitally or post-printed inks of an incompatible surface tension). Alternatively, the surface treatment layer 422 is not provided but the exposed surface of the protective layer 420 is treated to improve adhesion between the protective layer and the digitally printed layer 424. For example, instead of printing or coating the surface treatment layer 422 on the protective layer 420, the surface of the protective layer 420 (e.g., the surface that faces away from the carrier layer 102) can be treated to change energy of the surface (e.g., by changing the surface energy of the protective layer 420), to roughen, clean and prepare the surface, or the like, to thereby improve adhesion between the protective layer 420 and the digitally printed layer 424. The surface can be treated using one or more of a variety of techniques, such as by exposing the surface to a gas flame, exposing the surface to air plasma, using a corona treatment, exposing the surface to a chemical plasma, or the like.

The digitally printed layer 424 can include one or more inks that are digitally printed to form one or more images and/or indicia. As described above, these images can include variable data (e.g., different images and/or indicia for different labels) and/or non-variable data (e.g., the same image and/or indicia for each label). For example, the digitally printed layer 424 can include bar codes, variable embellishments and effects, QR codes, sequential numbering (e.g., between or among different labels), etc. The digitally printed layer 424 can include security features such as data and watermarks, watermarks with invisible marks for security detection (e.g., by handheld scanner or mobile device). The watermarks formed in the digitally printed layer 424 can be optically detected by an optical sensor (e.g., a camera on a mobile phone) and can cause the mobile device to take one or more actions, such as, performing a security validation check or loading a website connected with the article 212 to which the digitally printed layer 424 is eventually interconnected. The digitally printed layer 424 can include UV sensitive ink so that the images and/or indicia are only visible when exposed to UV light. The digitally printed layer 424 can include machine taggant inks or magnetic inks that can be electronically detected by a scanner. As another example, the digitally printed layer 424 can include inks that provide a unique effect, such as a gloss appearance, a matte appearance, a foil or metallic appearance, embossing, etc. These detectable designs, watermarks or inks can also be printed into the label by the non-digital parts of the process, i.e. screen printing of the magnetic or coded inks, to provide a more reliable functionality or detection by increase of deposit thickness or visibility. The digitally printed layers having images, indicia, text, numbers, or other graphics described herein can be referred to as graphic or graphics layers.

A tie layer 426 can be printed onto the digitally printed layer 424. Optionally, the tie layer 426 is not included in the label assembly 406. The tie layer 426 can be printed using a non-digital printing process, such as screen printing. The tie layer 426 assists in coupling the underlying layers 420, 422, 424 to the article 212 via the adhesive 108. The tie layer 426 can be formed from a polymeric material that softens and bonds with the article 212 when subjected to heat 216 or a combination of heat 216 and pressure 218. The adhesive 108 can be applied onto the tie layer 426 or onto the digitally printed layer 424 (if the tie layer 426 is not included in the label assembly 400).

Alternatively, the tie layer 426 and the adhesive 108 can be combined into a single layer. For example, the tie layer 426 and the adhesive 108 shown in FIG. 4 (and in other Figures where the tie layer 426 directly contacts or otherwise abuts the adhesive 108) may be replaced by a single layer representing a combination of the materials forming the tie layer 426 and the adhesive 108.

One or more surfaces of the label assembly 400 can be treated to change the energy, surface tension, or smoothness of the surfaces and thereby improve the adhesion of a layer to the treated surface. For example, surfaces of one or more of the layers 420, 422, 424, and/or 426 can be exposed to an air plasma (e.g., a corona treatment), chemical plasma, gas flame, or the like, to roughen the surface (e.g., on a microscopic scale), to change the surface tension of the layers 420, 422, 424, and/or 426, or to otherwise improve adhesion between the surface and another layer 420, 422, 424, or 426.

As described above, the label assembly 400 can be placed into contact with the article 212 such that the adhesive 108 contacts the surface 214 of the article 212. Heat 216 or a combination of heat 216 and pressure 218 is applied to the surface 110 of the carrier layer 102 to separate the label 406 from the carrier layer 102 and adhere the label 406 to the article 212. The label 406 can be adhered to articles 212 such as cosmetic containers, personal care products (e.g., toothbrushes, hairbrushes, etc.), other polymer surfaces, etc.

FIG. 5 illustrates another example of a hybrid heat transfer label assembly 500. The label assembly 500 can represent the label assembly 100 shown in FIGS. 1 and 2, and includes a multi-layered label 506 that can represent the multi-layered label 106 shown in FIGS. 1 through 3. The label assembly 500 and the label 506 can represent another embodiment of the label assembly 400 and the label 406 shown in FIG. 4. One difference between the label assemblies 400, 500 and between the labels 406, 506 is the presence of an additional graphic layer 528 and, optionally, a backup or backer layer 530. The graphic layer 528 can be printed onto the tie layer 426 or onto the digitally printed layer 424 (if the tie layer 426 is not included in the label 506). The graphic layer 528 can include one or more images and/or indicia that are printed in a non-digital manner (e.g., using screen printing). The graphic layer 528 is printed above the digitally printed layer 424 such that the digitally printed layer 424 is on top of the graphic layer 528 once the label 506 is adhered to the article 212.

The graphic layer 528 can be printed using a non-digital technique, such as screen printing. The graphic layer 528 can be a layer of a solid (e.g., the same) color of ink, or may include different colored inks in different areas of the graphic layer 528. Optionally, the graphic layer 528 can include images and/or indicia. The digitally printed layer 424 overlaying the graphic layer 528 can provide for various appearances, such as a different background color (than the article 212), increased contrast between the digitally printed layer 424 and the article 212, or the like.

The backup layer 530 can be printed using a non-digital technique, such as screen printing. The backup layer 530 can be a layer of a solid (e.g., the same) color of ink, such as white, black, or the like. In one embodiment, the backup layer 530 is printed using a white pigment. For example, the backup layer 530 can be formed of a white ink formulation including a resin solution (formulated from 36.73 percent by weight ethyl 3-ethoxypropionate, 4.51 percent by weight cyclohexanone, 4.61 percent by weight Estane® 5703 thermoplastic polyurethane resin and 1.14 percent by weight CAB-381-20 cellulose ester resin), 1.84 percent by weight Nanomer® 1.28E nanoclay, white paste (formulated from 18.66 percent by weight ethyl 3-ethoxypropionate, 3.96 percent by weight cyclohexanone, 5.66 percent by weight Estane® 5703, and 18.86 percent by weight TIOXIDE® TR90 titanium dioxide), 0.86 percent by weight INEOS® IJI silica gel, 0.17 percent by weight TEGO® Foamex N defoamer and 3.00 percent Desmodur® N-75 aliphatic polyisocyanate. The white ink can be screen printed through a stainless-steel mesh, for example, with 270 lines per inch, on top of the tie layer 20. The white ink can be applied once or via multiple passes. The layer 530 can be formed from one or more rubber-based inks, such as a rubber-based screen ink.

Optionally, the backup layer 530 can include images and/or indicia. The backup layer 530 can make the images, indicia, and/or colors of the digitally printed layer 424 and/or graphic layer 528 clearer and/or have increased contrast relative to the label 506 not including the backup layer 530. For example, the backup layer 530 can prevent the color of the underlying article 212 (once the label 506 is applied to the article 212) from strikethrough or making the images and/or indicia harder to see.

In another embodiment, the label assembly 500 does not include the surface treatment layer 422, the tie layer 426, and/or the backup layer 530. One or more surfaces of the label assembly 500 can be treated to change the energy of the surface(s), change the surface tension of the surface(s), or roughen the surfaces and thereby improve the adhesion of a layer to the treated surface, as described above.

The label assembly 500 can be placed into contact with the article 212 such that the adhesive 108 contacts the surface 214 of the article 212. Heat 216 or a combination of heat 216 and pressure 218 is applied to the surface 110 of the carrier layer 102 to separate the label 506 from the carrier layer 102 and adhere the label 506 to the article 212. The label 506 can be adhered to articles 212 such as cosmetic containers, personal care products (e.g., toothbrushes, hairbrushes, etc.), other polymer surfaces, etc.

FIG. 6 illustrates another example of a hybrid heat transfer label assembly 600. The label assembly 600 can represent the label assembly 100 shown in FIGS. 1 and 2, and includes a multi-layered label 606 that can represent the multi-layered label 106 shown in FIGS. 1 through 3. As shown, the label assembly 600 includes the carrier layer 102, the protective layer 420 and the digitally printed layer 424, and optionally can include the surface treatment layer 422. In another embodiment, the label assembly 600 does not include the surface treatment layer 422.

The label assembly 600 includes a backup layer 630 that can be the same as the backup layer 530, except that the backup layer 530 can be formed from a single printing pass while the backup layer 630 can be formed from multiple printing passes. For example, the backup layer 530 can be printed from a single application of ink via screen printing while the backup layer 630 can be printed from several applications of ink via screen printing. As a result, the backup layer 630 may be thicker than the backup layer 530 and/or provide increased contrast between the digitally printed layer 424 and the underlying article 212. Alternatively, the backup layer 530 can be printed in multiple passes and/or the backup layer 630 can be printed in a single pass.

The label assembly 600 includes an adhesive 608 that can represent the adhesive 108. The adhesive 608 can be the same as the adhesive 108, except that the adhesive 108 can be formed from a single printing pass of the adhesive material while the adhesive 608 can be formed from multiple printing passes. For example, the adhesive 108 can be printed from a single application of adhesive via screen printing while the adhesive 608 can be printed from several applications of adhesive via screen printing. As a result, the adhesive 608 may be thicker than the adhesive 108 and/or provide increased adhesion or coupling to the underlying article 212. Alternatively, the adhesive 108 can be printed in multiple passes and/or the adhesive 608 can be printed in a single pass. One or more surfaces of the label assembly 600 can be treated to change the energy of the surface(s), change the surface tension of the surface(s), or roughen the surfaces and thereby improve the adhesion of a layer to the treated surface, as described above. For example, the surface of the label assembly 600 may be heated, exposed to plasma, or the like.

As described above, the label assembly 600 can be placed into contact with the article 212 such that the adhesive 608 contacts the surface 214 of the article 212. Heat 216 or a combination of heat 216 and pressure 218 is applied to the surface 110 of the carrier layer 102 to separate the label 606 from the carrier layer 102 and adhere the label 606 to the article 212. The label 606 can be adhered to fabric articles 212, such as medical fabrics, sports and safety fabrics, automotive fabrics, and the like. The increased adhesive 608 can assist in keeping the label 606 affixed to the fabric (relative to the labels 406, 506).

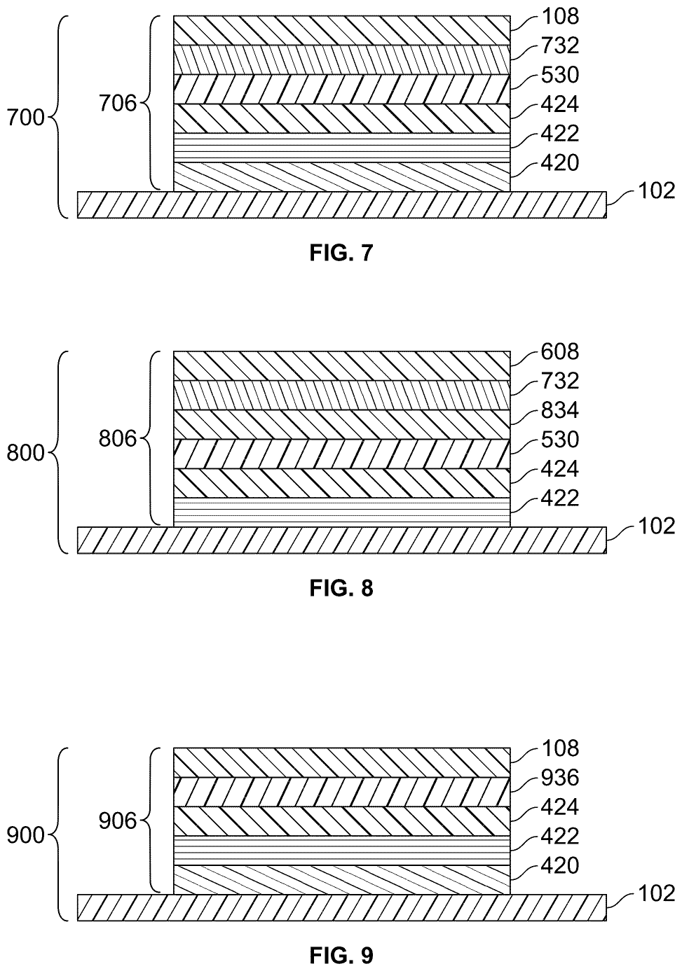

FIG. 7 illustrates another example of a hybrid heat transfer label assembly 700. The label assembly 700 can represent the label assembly 100 shown in FIGS. 1 and 2, and includes a multi-layered label 706 that can represent the multi-layered label 106 shown in FIGS. 1 through 3. As shown, the label assembly 700 includes the carrier layer 102, the protective layer 420, the digitally printed layer 424, the backup layer 530, and the adhesive 108, and optionally can include the surface treatment layer 422. In another embodiment, the label assembly 700 does not include the surface treatment layer 422.

The label assembly 700 includes a blocker layer 732 that can prevent dyes, stains, etc. migrating from the article 212 to the backup layer 530 and/or the digitally printed layer 424. The blocker layer 732 can be formed from the same materials as the protective layer 420 or from carbons, polyamides, acrylics or other polymers that can be applied in a non-digital printer and that can form a barrier to dyes, stains, etc. The blocker layer 732 can be printed onto the backup layer 530. This can help ensure that the color other features of the appearance of the digitally printed layer 424 and/or the backup layer 530 is not changed by dyes, stains, or the like, from the article 212. One or more surfaces of the label assembly 700 can be treated to change the energy of the surface(s), change the surface tension of the surface(s), or roughen the surfaces and thereby improve the adhesion of a layer to the treated surface, as described above.

The label assembly 700 can be placed into contact with the article 212 such that the adhesive 108 contacts the surface 214 of the article 212. Heat 216 or a combination of heat 216 and pressure 218 is applied to the surface 110 of the carrier layer 102 to separate the label 706 from the carrier layer 102 and adhere the label 706 to the article 212. The label 706 can be adhered to fabric articles 212, such as medical fabrics, sports and safety fabrics, automotive fabrics, and the like. The blocker layer 732 can help prevent sweat, bodily fluids, dyes, or other sources of stains from changing the appearance of the label 706.

FIG. 8 illustrates another example of a hybrid heat transfer label assembly 800. The label assembly 800 can represent the label assembly 100 shown in FIGS. 1 and 2, and includes a multi-layered label 806 that can represent the multi-layered label 106 shown in FIGS. 1 through 3. As shown, the label assembly 800 includes the carrier layer 102, the digitally printed layer 424, the backup layer 530, the blocker layer 732, and the adhesive 608, and optionally can include the surface treatment layer 422. In another embodiment, the label assembly 700 does not include the surface treatment layer 422 and/or the blocker layer 732.

The label assembly 800 includes a tie layer 834 that can be printed (using a non-digital technique) onto the backup layer 530. For example, the tie layer 834 can be screen printed on the backup layer 530. The tie layer 834 can attach the underlying layers 102, 422, 424, 530, 834, where these layers are included, to the blocker layer 732. The tie layer 834 can be formed from a polymeric material that softens and bonds with blocker layer 732 when subjected to heat and pressure during transfer of the label 806 to the article 212. For example, the tie layer 834 can be formed from a lacquer or other light-transmissive (e.g., clear) material.

In one embodiment, the backup layer 530 can be a multiple strike or pass layer. For example, the backup layer 530 can be formed by several passes or printing operations instead of a single printing pass, as described above. One or more surfaces of the label assembly 800 can be treated to change the energy of the surface(s), change the surface tension of the surface(s), or roughen the surfaces and thereby improve the adhesion of a layer to the treated surface, as described above.

The label assembly 800 can be placed into contact with the article 212 such that the adhesive 608 contacts the surface 214 of the article 212. Heat 216 or a combination of heat 216 and pressure 218 is applied to the surface 110 of the carrier layer 102 to separate the label 806 from the carrier layer 102 and adhere the label 806 to the article 212. The label 806 can be adhered to fabric articles 212, such as medical fabrics, sports and safety fabrics, automotive fabrics, and the like. The blocker layer 832 can help prevent sweat, bodily fluids, dyes, or other sources of stains from changing the appearance of the label 806.

FIG. 9 illustrates another example of a hybrid heat transfer label assembly 900. The label assembly 900 can represent the label assembly 100 shown in FIGS. 1 and 2, and includes a multi-layered label 906 that can represent the multi-layered label 106 shown in FIGS. 1 through 3. As shown, the label assembly 900 includes the carrier layer 102, the surface treatment layer 422, the digitally printed layer 424, and the adhesive 108. In another embodiment, the label assembly 900 does not include the protective layer 420, the surface treatment layer 422 and/or the adhesive 108.

The label assembly 900 includes a rubber layer 936 that can be printed (using a non-digital technique) onto the digitally printed layer 424. For example, the rubber layer 936 can be formed from rubber or ink with rubber that is screen printed on the digitally printed layer 424. The rubber layer 936 can enable the label 906 to be adhered to a rubber surface as the article 212, such as an automotive component (e.g. a tire, hose or a belt) or other vulcanized material. The label 906 may remain adhered to the rubber article 212 without the rubber layer 936 in one embodiment. The rubber layer 936 can be black or white in color to also function as a backer layer, as described above. Alternatively, the rubber layer 936 may have another color or combination of colors. One or more surfaces of the label assembly 900 can be treated to change the energy of the surface(s), change the surface tension of the surface(s), or roughen the surfaces and thereby improve the adhesion of a layer to the treated surface, as described above.

The label assembly 900 can be placed into contact with the article 212 such that the adhesive 108 or the rubber layer 936 contacts the surface 214 of the article 212. Heat 216 or a combination of heat 216 and pressure 218 is applied to the surface 110 of the carrier layer 102 to separate the label 906 from the carrier layer 102 and adhere the label 906 to the article 212. The label 906 can be adhered to rubber or vulcanized articles 212, such as automotive hoses, tires, or the like.

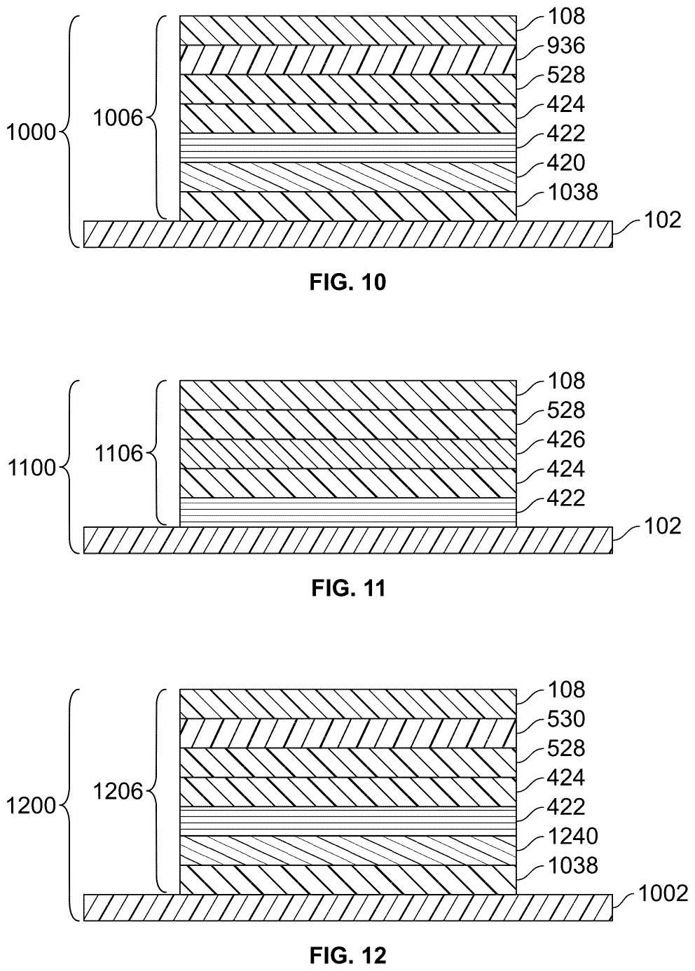

FIG. 10 illustrates another example of a hybrid heat transfer label assembly 1000. The label assembly 1000 can represent the label assembly 100 shown in FIGS. 1 and 2, and includes a multi-layered label 1006 that can represent the multi-layered label 106 shown in FIGS. 1 through 3. As shown, the label assembly 1000 includes a carrier layer 1002, the surface treatment layer 422, the digitally printed layer 424, the tie layer 426, the additional graphic layer 528, the rubber layer 936, and the adhesive 108. In another embodiment, the label assembly 1000 does not include the protective layer 420, the surface treatment layer 422 and/or the additional graphic layer 528.

The carrier layer 1002 can be carrier layer 102 shown in FIGS. 1 through 3 but without a release coating already on the carrier layer 1002. For example, while the carrier layer 102 may be obtained with the release coating already present on the carrier layer 102, the carrier layer 1002 may not have any release coating. A release coating 1038 can be printed (e.g., in a non-digital way, such as via screen, gravure or flexographic printing) onto the carrier layer 1002. For example, silicone, wax, or other materials that release the carrier layer 1002 from the other layers 420, 422, 424, 528, and/or 936 may be added to the carrier layer 1002. One or more surfaces of the label assembly 1000 can be treated to change the energy of the surface(s), change the surface tension of the surface(s), or roughen the surfaces and thereby improve the adhesion of a layer to the treated surface, as described above.

The label assembly 1000 can be placed into contact with the article 212 such that the adhesive 108 or the rubber layer 1036 contacts the surface 214 of the article 212. Heat 216 or a combination of heat 216 and pressure 218 is applied to the surface 110 of the carrier layer 102 to separate the label 1006 from the carrier layer 102 and adhere the label 1006 to the article 212. The label 1006 can be adhered to rubber articles 212, such as automotive belts, hoses, tires, or the like.

FIG. 11 illustrates another example of a hybrid heat transfer label assembly 1100. The label assembly 1100 can represent the label assembly 100 shown in FIGS. 1 and 2, and includes a multi-layered label 1106 that can represent the multi-layered label 106 shown in FIGS. 1 through 3. As shown, the label assembly 1100 includes the carrier layer 102, the surface treatment layer 422, the digitally printed layer 424, the tie layer 426, the additional graphic layer 528, and the adhesive 108. In another embodiment, the label assembly 1100 does not include the surface treatment layer 422, the tie layer 426, and/or the additional graphic layer 528. One or more surfaces of the label assembly 1100 can be treated to change the energy of the surface(s), change the surface tension of the surface(s), or roughen the surfaces and thereby improve the adhesion of a layer to the treated surface, as described above.

The label assembly 1100 can be placed into contact with the article 212 such that the adhesive 108 contacts the surface 214 of the article 212. The article 212 can be formed of metal, fiber, or glass, and/or the surface 214 of the article 212 may include metal, fiber, or glass. Heat 216 or a combination of heat 216 and pressure 218 is applied to the surface 110 of the carrier layer 102 to separate the label 1106 from the carrier layer 102 and adhere the label 1106 to the pre-heated article 212.

FIG. 12 illustrates another example of a hybrid heat transfer label assembly 1200. The label assembly 1200 can represent the label assembly 100 shown in FIGS. 1 and 2, and includes a multi-layered label 1206 that can represent the multi-layered label 106 shown in FIGS. 1 through 3. As shown, the label assembly 1200 includes the uncoated carrier layer 1002, the release layer 1038, a protective or special effects layer 1240, the surface treatment layer 422, the digitally printed layer 424, the additional graphic layer 528, the backup layer 530, and the adhesive 108. In another embodiment, the label assembly 1200 does not include the surface treatment layer 422, the additional graphic layer 528, and/or the backup layer 530.

The protective or special effects layer 1240 can include one or more materials that add a gloss appearance to the underlying digitally printed layer 424 or a matte appearance to the underlying digitally printed layer 424. Optionally, the special effects layer 1240 can include a metal foil (or HRI High Reflective Index ZnS foil) to provide a metallic appearance to the label 1206. This metal foil may be sufficiently thin that the digitally printed layer 424 is visible through the layer 1240 once the label 1206 is applied to the article 212 and the carrier layer 1002 is removed. The special effects layer 1240 can be an embossed layer that has one or more graphics or indicia embossed into the layer 1240. The special effects layer 1240 can be digitally printed using the same digital printer that prints the digitally printed layer 424 or using another digital or analogue printing method. Alternatively, the layer 1240 can be the protective layer 420. One or more surfaces of the label assembly 1200 can be treated to change the energy of the surface(s), change the surface tension of the surface(s), or roughen the surfaces and thereby improve the adhesion of a layer to the treated surface, as described above.

The label assembly 1200 can be placed into contact with the article 212 such that the adhesive 108 contacts the surface 214 of the article 212. The article 212 can be formed of metal, fiber, or glass, and/or the surface 214 of the article 212 may include metal, fiber, or glass. Heat 216 or a combination of heat 216 and pressure 218 is applied to the surface 110 of the carrier layer 102 to separate the label 1206 from the carrier layer 102 and adhere the label 1206 to the article 212.

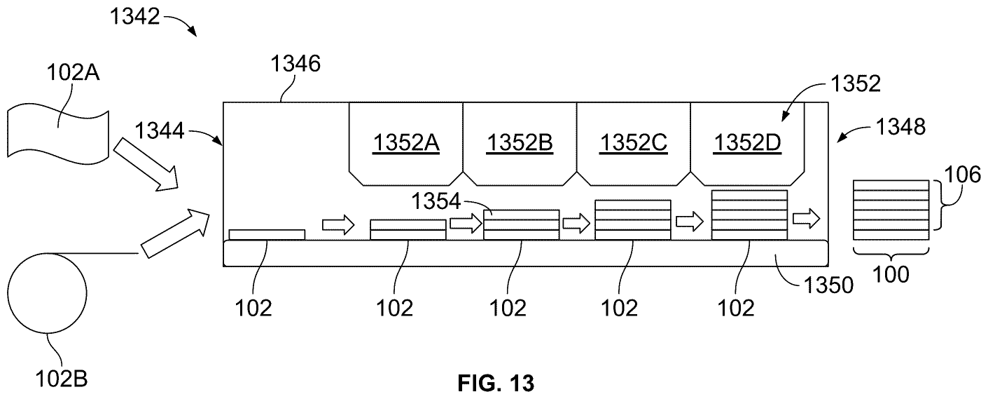

FIG. 13 illustrates one example of an in-line printing system 1342 that can be used to create one or more of the hybrid digital heat transfer label assemblies described herein. The in-line printing system 1342 can print several or all of the layers in the label assembly 100 without removing the partially formed label assembly from the printing system 1342. For example, the carrier layer 102 of the label assembly 100 can be inserted into the printing system 1342 in an input end 1344 of an outer housing 1346 of the printing system 1342 and not removed from the housing 1346 of the printing system 1342 (via an outlet end 1348 of the housing 1346) until manufacture of the label assembly 100 is complete.

For example, the carrier layer 102 can be provided as individual sheets 102A (e.g., in sheet form) or as a continuous roll 102B (e.g., in roll form) into the printing system 1342. One or more conveyors, cylinders or rollers 1350 can carry the carrier layer 102 to and/or through several printers 1352 (e.g., printers 1352A-E). The number of printers 1352 is provided as one example. Each of the printers 1352 can print one or more additional layers 1354 onto the carrier layer 102 and/or other layers 1354 already on the carrier layer 102, as shown in FIG. 13. The layers 1354 can represent the layers 420, 422, 424, 426, 528, 530, 608, 630, 732, 834, 936, 1002, 1038, and/or 1240, as described above.

At least one of the printers 1352 can be a digital printer (e.g., an ink jet printer) while at least one other printer 1352 can be a printer that is not a digital printer (e.g., a screen printer). For example, a digital printer (e.g., 1352B) can be disposed downstream of one non-digital printer (e.g., 1352A) and upstream of another non-digital printer (e.g., 1352C) such that the digitally printed layer printed by the digital printer is disposed between the non-digitally printed layers. Optionally, one or more of the printers 1352 can include and/or one or more of the printers 1352 can represent a heating device that heats, dries, and/or cures the uppermost layer on the carrier layer 102 as the layers on the carrier layer 102 pass through the printer 1352 or heating device. Examples of such a heating device include air impingement driers, ovens, infrared lamps, and the like.

As shown, the carrier layer 102 passes through or beneath the printers 1352 so that the various layers in the label assembly 100 are sequentially printed without removing the carrier layer 102 or the printed layers from the printing system 1342. As described above, one or more of the printers 1352 may deposit a layer in a single pass or strike, or by depositing the layer in multiple passes or strikes. Once the layers forming the label 106 are printed onto the carrier layer 102, the label 106 (in roll or sheet form) may be removed from the printing system 1342. The in-line printing system 1342 can form the label assembly 100 and decrease the number of times that the label assembly 100 is handled by an operator, thereby decreasing registration errors between the layers, reducing printing time, and the like.

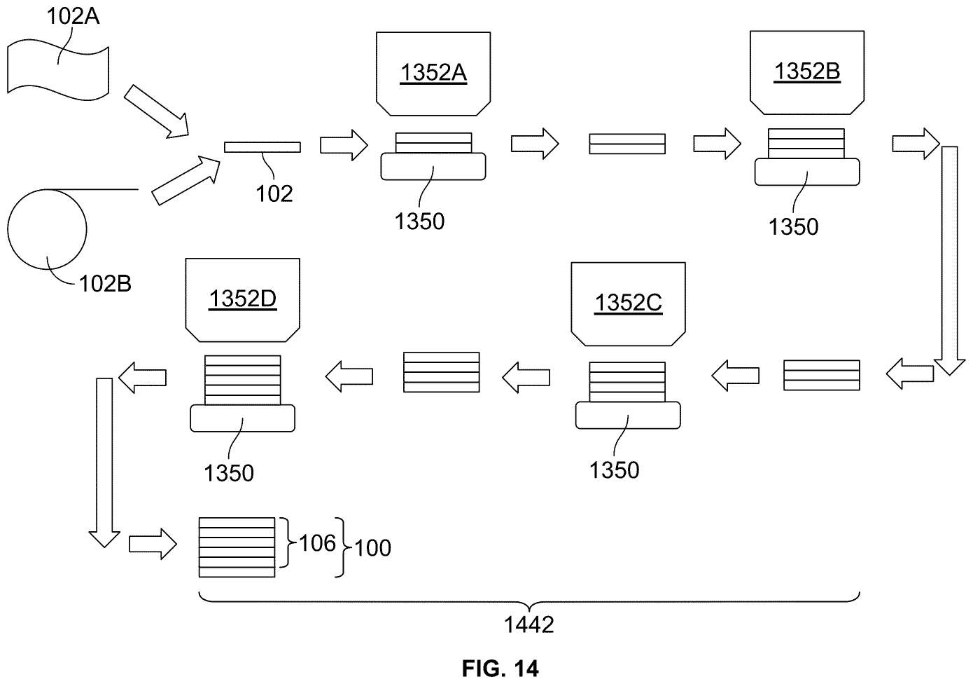

FIG. 14 illustrates another example of a printing system 1442 that can be used to create one or more of the hybrid digital heat transfer label assemblies described herein. In contrast to the in-line printing system 1342, the printing system 1442 has two or more separate printers 1352 that do not directly supply the carrier layer 102 (and any printed layers) from one printer 1352 to the next printer 1352. Instead, the carrier layer 102 and any printed layers are removed from one printer 1352 (e.g., by an operator of the printing system 1442) and then inserted into the next printer 1352.

A method for creating a hybrid heat transfer label assembly can include obtaining a carrier layer. The method can be used to create one or more of the label assemblies described herein. If the carrier layer does not include a release coating or layer, the method can include subsequently printing (e.g., in a non-digital manner) a release coating or layer onto the carrier layer. The method also can include subsequently printing, in a non-digital manner, one or more underlying layers on the carrier layer (with the release coating). These underlying layers can include one or more of the protective layer, the surface treatment layer, and/or the special effects layer.

The method includes subsequently digitally printing one or more images and/or indicia on the underlying layer(s). These images and/or indicia can be the digitally printed layer described above. The method includes subsequently printing (e.g., in a non-digital manner) one or more additional layers on the digitally printed layer. These additional layers can include the tie layer, the adhesive, the additional graphic layer, the backup layer, the blocker layer, and/or the rubber layer described above. This forms one or more of the label assemblies described herein.

In one embodiment, a hybrid heat transfer label assembly is provided. The label assembly includes a carrier layer, a non-digitally printed protective layer disposed above the carrier layer, a digitally printed layer disposed above the non-digitally printed protective layer, and a non-digitally printed layer disposed above the digitally printed layer. The non-digitally printed protective layer, the digitally printed layer, and the non-digitally printed layer form a label that is configured to separate from the carrier layer and adhere to an article upon application of heat to the carrier layer.

Optionally, the digitally printed layer is visible through the non-digitally printed protective layer once the label is adhered to the article.

Optionally, the non-digitally printed layer includes an adhesive.

Optionally, the non-digitally printed layer includes a tie layer.

Optionally, the non-digitally printed layer includes a screen-printed graphic layer.

Optionally, the non-digitally printed layer includes a screen-printed backup layer.

Optionally, the non-digitally printed layer includes a blocker layer that prevents stains from migrating from the article to the digitally printed layer.

Optionally, the non-digitally printed layer includes a lacquer layer.

Optionally, the non-digitally printed layer includes a rubber layer.

Optionally, the non-digitally printed layer is a first non-digitally printed layer, and the label assembly also can include a second non-digitally printed layer disposed above the first non-digitally printed layer and the digitally printed layer.

A method for producing a hybrid heat transfer label assembly also is provided. The method includes printing a protective layer above a carrier layer using a first non-digital printer, digitally printing a digitally printed layer above the non-digitally printed protective layer, and printing a non-digitally printed layer above the digitally printed layer using the first non-digital printer or a second non-digital printer. The protective layer, the digitally printed layer, and the non-digitally printed layer form a label that is configured to separate from the carrier layer and adhere to an article upon application of heat to the carrier layer.

Optionally, the protective layer is printed as one or more of a clear, a translucent, or a light-transmissive layer.

Optionally, the protective layer and the non-digitally printed layer are screen printed.

Optionally, the non-digitally printed layer is printed using an adhesive.

Optionally, the non-digitally printed layer is printed as a tie layer.

Optionally, the non-digitally printed layer is screen printed as a graphic layer.

Optionally, the non-digitally printed layer is screen printed as a backup layer.

Optionally, the non-digitally printed layer is printed as a blocker layer that prevents stains from migrating from the article to the digitally printed layer.

Optionally, the non-digitally printed layer is printed using a lacquer.

In another embodiment, another method for producing a hybrid heat transfer label assembly is provided. The method includes screen printing a protective layer onto a carrier layer, digitally printing one or more of a graphic or indicia above the protective layer, screen printing one or more additional layers above the one or more of the graphic or the indicia that are digitally printed, and applying an adhesive above the one or more additional layers to form a hybrid heat transfer label assembly.

In the field of label manufacturing and application, there is a persistent challenge in achieving a reliable and efficient transfer of labels onto various substrates. Some known methods often involve printed coatings that require precise alignment and application techniques, which can be cumbersome and prone to errors. These methods typically rely on die-cutting processes or multi-step applications that can lead to inefficiencies and increased production costs. Furthermore, the adhesion of labels to substrates such as rubber, polypropylene, and other materials often requires specific chemical treatments or surface preparations, which can complicate the manufacturing process and limit the versatility of the labeling system.

Solutions that have been previously developed have attempted to address these issues through various techniques, such as using printed coatings or multi-layered constructions. However, these approaches often suffer from several disadvantages. Printed coatings can be inconsistent, leading to variations in label quality and adhesion strength. Additionally, the reliance on die-cutting or other mechanical separation techniques can result in waste and increased material costs. Moreover, the need for specific chemical treatments or surface preparations can limit the applicability of these solutions to a narrow range of substrates, reducing their overall utility and adaptability in diverse industrial applications.

One or more additional embodiments of the inventive subject matter described herein provide an innovative solution to these challenges by introducing a non-printed coating method that utilizes a chemically dependent adhesive system. This system is designed to create a selective transfer of labels onto a wide variety of substrates without the need for die-cutting or extensive surface preparation. In one example, a Meyer rod is used to apply a coating that forms a protective layer to ensure a uniform application of the protective layer. This protective layer can be chemically incompatible with the substrate or article. This incompatibility allows for a clean breakaway of the label assembly from the carrier when the adhesive is activated, resulting in a precise and efficient transfer process. The versatility of this approach is further enhanced by the ability to adapt to different substrate materials, such as rubber, steel, and various plastics, through the selection of appropriate chemical compositions for the adhesive and protective layers. This approach not only simplifies the label application process but also reduces waste and production costs, offering a significant advancement over existing technologies.

Chemical incompatibility refers to a situation where two or more chemical substances react adversely when combined, leading to undesirable effects such as degradation, precipitation, or the formation of harmful byproducts. This incompatibility can prevent the substances from functioning as intended, particularly in applications where specific chemical interactions are required for adhesion, stability, or performance. For example, chemical incompatibility between layers or surfaces can mean that no chemical-physical interactions are formed between the layers or surfaces, whereas chemically compatible means that there are chemical-physical interactions formed between the layers or surfaces. The chemical-physical interactions are the forces that hold atoms or molecules in the different layers or surfaces together to chemically bind the layers together or the surfaces together. The chemical-physical interactions between the layers or surfaces can be covalent bonds, ionic bonds, or metallic bonds. In one example, chemical-physical interactions between layers means that the layers cannot be separated without damaging or destroying the layers.

A clean breakaway occurs when a label assembly is separated from a carrier along desired lines or curves, and not outside of those desired lines or curves. For example, labels may have a rectangular shape, and a clean breakaway occurs when the label assembly keeps the rectangular shape after being separated from the carrier, with no visible curves or deviations from the lines forming the border of the rectangular shape.

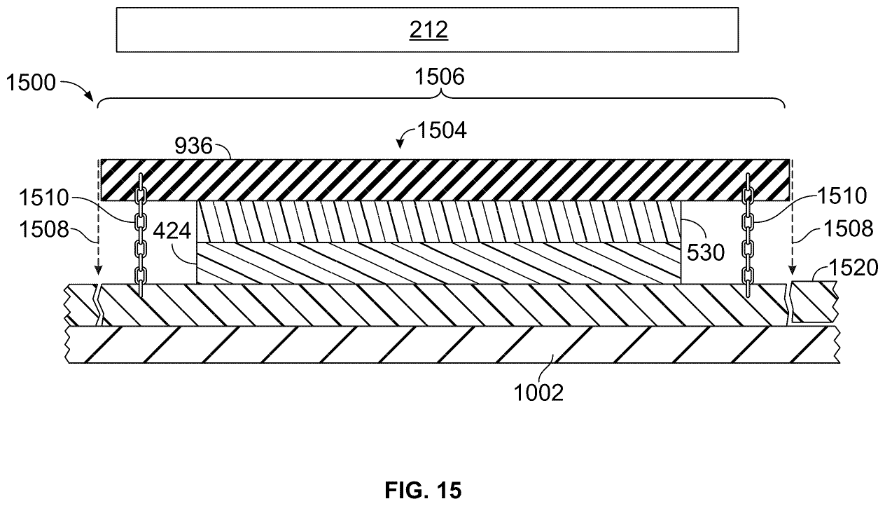

FIG. 15 illustrates another example of a hybrid heat transfer label assembly 1500. The label assembly 1500 can represent the label assembly 100 shown in FIGS. 1 and 2, and includes a multi-layered label 1506 that can represent the multi-layered label 106 shown in FIGS. 1 through 3. As described herein, a coating can be applied in the label assembly 100 as a non-digitally printed layer using a Meyer rod coater instead of screen printing, flexographic printing, gravure printing, or pad printing. This can provide for increased control over the thickness of the coating, as well as more consistent thickness of the coating over the entirety of the label 1506 (when compared with these other printing techniques).

The label assembly 1500 includes the uncoated carrier layer 1002, and a chemically incompatible coated protective layer 1520. The carrier layer 1002 optionally can be the carrier layer 102. The carrier layer 1002 can be formed from polypropylene, such as extruded monoaxially oriented polypropylene (MOPP). This material is a type of polypropylene film that has been stretched in one direction (e.g., in a monoaxial orientation) during manufacturing to improve the strength, stiffness, and barrier properties of the carrier layer 1002. This causes the carrier layer 1002 to be mechanically stronger (e.g., have a higher tensile strength) in this direction than other carrier layers, and allows the carrier layer 1002 to be easier to tear in certain directions.

The chemically incompatible coated protective layer 1520 can be non-digitally printed directly onto the carrier layer 1002. For example, no other materials or layers or coatings may be between the carrier layer 1002 and the protective layer 1520. The protective layer 1520 is referred to as a non-digitally printed, breakaway protective coating as the protective layer 1520 is designed to tear from itself and break away from the carrier layer 1502 during application of the label 1506 onto the article 212. The protective layer 1520 is chemically incompatible with the carrier layer 1002 (to prevent formation of chemical-physical interactions with the carrier layer 1002), but is chemically compatible with an adhesive layer 936 (to form chemical-physical interactions with the adhesive layer 936). As described herein, this adhesive layer 936 forms chemical-physical interactions with the protective layer 1520, which causes the protective layer 1520 to perforate and break away only where there is contact or overlap between the adhesive layer 936 and the protective layer 1520. The protective layer 1520 can be printed onto or applied to all or substantially all (e.g., at least 95% of the surface area on one side) of the carrier layer 1002. As described herein, chemical-physical interactions dictate where the protective layer 1520 tears to separate the label 1506 from the label assembly 1500. As a result, the protective layer 1520 can be applied to most, if not all, of one side of the carrier layer 1002.

The protective layer 1520 can be formed from materials that are chemically incompatible with the article 212 to which the label 1506 is applied. For example, the protective layer 1520 does not form a chemical-physical interactions with the article 212 or the surface of the article 212 when the label 1506 is applied to the article 212, regardless of whether heat and/or pressure are used to apply the label 1506 to the article 212. In one example, the protective layer 1520 can be non-digitally printed by forming the layer 1520 from PVC that is coated onto the carrier layer 1002 using a Meyer rod. The article 212 or the surface of the article 212 to which the label 1506 is applied can be formed from rubber, such as vulcanized rubber (used in an automotive product, such as a tire, hose, or the like), that does not form a chemical-physical interactions with the protective layer 1520. Alternatively, the article 212 or surface of the article 212 can be formed from steel, graphite, PET, polypropylene, acrylonitrile butadiene styrene (ABS) plastic, cotton, polyester, leather, or the like, which does not form chemical-physical interactions with the protective layer 1520.

The label assembly 1500 includes the digitally printed layer 424 on the protective layer 1520. The digitally printed layer 424 can be digitally printed using a toner or inkjet printer, such as a printer that can digitally print cyan, magenta, yellow, black, white, orange, violet, and/or green colors directly onto the protective layer 1520 to form the digitally printed layer 424 described herein. The label assembly 1500 includes the backup or backer layer 530 that can be printed directly onto the digitally printed layer 424. The backup layer 530 can be chemically compatible with the article 212 or surface of the article 212 to which the label 1506 is applied. For example, the backup layer 530 can be rubber-based ink that is screen printed onto the digitally printed layer 424. The backup layer 530 can provide a solid color as a backup to the digitally printed layer 424. For example, the backup layer 530 can be a solid single color (e.g., only white, only black, or only another single color) that increases the contrast or otherwise improves the appearance of the graphics, text, numbers, or other indicia formed by the digitally printed layer 424 once the label 1506 is adhered to the article 212.

The label assembly 1500 includes the rubber layer 936 that can be printed (using a non-digital technique) onto the backup layer 530. For example, the rubber layer 936 can be formed from rubber or ink with rubber that is screen printed on the backup layer 530. Alternatively, the backup layer 530 and the rubber layer 936 can be formed as a single layer. The rubber layer 936 can be referred to as a chemically compatible adhesive layer. The rubber layer 936 can enable the label 1506 to be adhered to a rubber surface as the article 212, such as an automotive component or other vulcanized material. One or more surfaces of the label assembly 1500 can be treated to change the energy of the surface(s), change the surface tension of the surface(s), or roughen the surfaces and thereby improve the adhesion of a layer to the treated surface, as described above. The chemically compatible adhesive layer or rubber layer 936 can be chemically compatible with the article 212 or the surface of the article 212 such that chemical-physical interactions form between the article 212 and the adhesive or rubber layer 936.

As schematically shown, the protective layer 1520 forms chemical-physical interactions 1510 with the adhesive layer or rubber layer 936 outside of the design layers (e.g., the digitally printed layer 424 and the backup layer 530 that provide the appearance or design of the label 1506). The chains representing the chemical-physical interactions 1510 are not actual chains, but represent the chemical-physical interactions 1510 between the adhesive/rubber layer 936 and the protective layer 1520. As shown, the chains representing the chemical-physical interactions 1510 do not extend to or into the carrier layer 1002. This indicates the lack or an absence of any chemical-physical interactions 1510 between the carrier layer 1002 and the protective layer 1520 (or between the carrier layer 1002 and any other layer 424, 530, 936).

The protective layer 1520 does not release from the carrier layer 1002 and does not tear or separate from itself without a chemical-physical interactions 1510. The protective layer 1520 is formed from materials that do not have any chemical compatibility to the article 212 to which the protective layer 1520 is applied. For example, an application surface 1504 of the rubber or adhesive layer 936 can be placed onto the article 212. Heat and pressure can be applied onto the label assembly 1500 on top of or through the carrier layer 1002. The rubber or adhesive layer 936 chemically bonds with the article 212 or the surface of the article 212 to form chemical-physical interactions 1510 between the rubber or adhesive layer 936 and the article 212. As a result, chemical-physical interactions 1510 exist between the protective layer 1520 and the rubber adhesive layer 936 (and between the rubber adhesive layer 936 and the article 212).

When the label assembly 1500 is heated in combination with pressure using the chemically compatible adhesive layer 936, the chemical-physical interactions 1510 between the protective layer 1520 and the rubber adhesive layer 936 create a complete film encapsulation of the digital design layer 424 and non-digitally printed design layer (e.g., the layer 530). These design layers 424, 530 are completely sealed within and between (e.g., encapsulated) the protective layer 1520 and the adhesive rubber layer 936, with no part of the layers 424, 530 exposed. While FIG. 15 shows the lateral edges of the layers 424, 530 exposed, in practice, the portions of the layers 1520, 936 that are outside of these lateral edges form chemical-physical interactions 1510 with each other that seal, enclose, or encapsulate the entirety of the layers 424, 530 between and within the layers 1520, 936.

The chemical-physical interactions 1510 between the adhesive layer 936 and the article 212 permanently bonds the label 1506 to the article 212. When the carrier layer 1002 is pulled from the article 212, these chemical-physical interactions 1510 create a perforation or separation 1508 through the protective layer 1520 around the design of indicia created by the layers 424, 530. This perforation or separation 1508 can be a clean tear through the protective layer 1520 that follows the outer lateral edges of the layers 424, 530. The tear can be in locations that correspond to interfaces between the adhesive layer 936 and the protective layer 1520. For example, the protective layer 1520 tears at the outer edges of the locations where the adhesive layer 936 contacts, overlaps, or chemically bonds to the protective layer 1520. Although not shown in FIG. 15, the adhesive layer 936 may extend downward in FIG. 15 on opposite sides of the layers 424, 530 and contact the protective layer 1520. The outer lateral edges of the contact between the adhesive layer 936 and the protective layer 1520 are where the protective layer 1520 tears into different sections, with the section of the protective layer 1520 that overlaps, overlays, or contacts the adhesive layer 936 being removed from the carrier 1002 while other sections of the protective layer 1520 remain on the carrier layer 1002.

For example, the chemical-physical interactions 1510 of the adhesive 936 to the protective layer 1520 and the chemical-physical interactions 1510 of the adhesive 936 to the article 212 causes the label 1506 to separate from the carrier layer 1002 and causes the protective layer 1520 to tear in locations indicated by the perforations 1508. The portions of the protective layer 1520, the digitally printed layer 424, the backup layer 530 and the adhesive layer 936 that are between these locations remain on the article 212 as the label 1506, while the remainder of these layers 1520, 424, 530, 936 and the entire carrier layer 1002 is removed from the article 212 (and the carrier layer 1002 is removed from the label 1506). Stated differently, the shape of the label 1506 that breaks or tears away from the label assembly 1500 is defined by the locations or areas where the adhesive layer 936 and the protective layer 1520 overlap each other, where the adhesive layer 936 and the protective layer 1520 contact each other, and where the adhesive layer 936 and the protective layer 1520 chemically bond with each other. These overlapping, contacting, and chemically bond areas between the adhesive layer 936 and the protective layer 1520 define the outer boundaries of the label 1506 that is torn or broken away from the label assembly 1500. For example, if the adhesive layer 936 contacts, overlaps, and chemically bonds with the protective layer 1520 in areas that make the shape of the outer boundary of a square, then the label 1506 that tears or breaks away from the label assembly 1500 will have the shape of the square, and will include the portions of the label assembly 1500 that are within the boundary of the square shape (even if the adhesive layer 936 and protective layer 1520 do not contact or chemically bond with each other inside the square shape). As described herein, this adhesive layer 936 forms chemical-physical interactions with the protective layer 1520, which causes the protective layer 1520 to perforate and break away only where there is contact or overlap between the adhesive layer 936 and the protective layer 1520.

While the above description of the label 1506 focuses on adhering the label 1506 to a rubber or vulcanized rubber article 212, other materials may be used. For example, the materials used to form the protective layer 1520 and the adhesive layer 936 can be changed and selected to be chemically dependent on the article 212. For example, the materials used to form the adhesive layer 936 can be selected to form chemical-physical interactions 1510 with the article 212, the materials used to form the protective layer 1520 can be selected to form chemical-physical interactions 1510 with the adhesive layer 936, and the materials used to form the protective layer 1520 may not form chemical-physical interactions 1510 with the article 212. This provides for a clean breakaway of the label 1506 from the label assembly 1500.

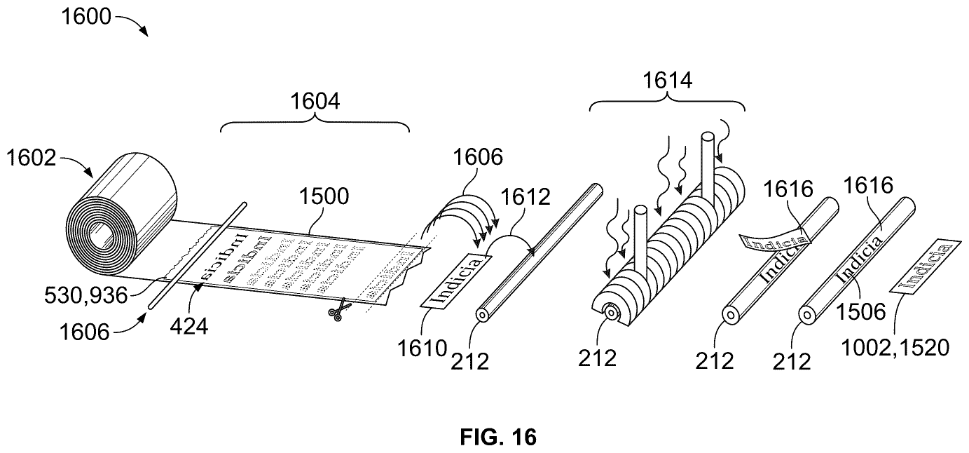

FIG. 16 illustrates one example of a method 1600 for constructing and/or applying the label 1506 shown in FIG. 15 to the article 212. For example, part of the method 1600 may include forming or manufacturing part of a hybrid heat transfer label assembly that includes a hybrid heat transfer label, and another part of the method 1600 may include applying the label from the assembly. Not all embodiments of the method 1600 are limited to only constructing, only applying, or both constructing and applying unless clearly and explicitly limited in that way. The article 212 is shown as a cylindrical or tubular body, such as a vulcanized rubber hose for an automobile, but alternatively can have another shape. The method 1600 can include the protective layer 1520 being printed (in a non-digital or digital manner) onto the carrier layer 1002 using a Meyer rod 1606, and the digitally printed layer 424 being digitally printed onto the protective layer 1520. The carrier layer 1002, protective layer 1520, and the digitally printed layer 424 may be moved, stored, or otherwise handled on a roll or spool 1602. At 1604, the non-digitally printed backer layer 530 is printed onto the digitally printed layer 424 as the digitally printed layer 424, the protective layer 1520, and the carrier layer 1002 are unwound from the roll or spool 1602. The non-digitally printed backer layer 530 can be printed using a Meyer rod 1606.

For example, a wire-wound rod or a metering rod can be used to apply a controlled, uniform layer of liquid onto the digitally printed layer 424 to form the non-digitally printed layer 530. The rod 1606 has a tightly wound wire, with the wire diameter of the wire controlling the amount of liquid applied to form the non-digitally printed layer 530. The rod 1606 is drawn across the surface of the digitally printed layer 424, spreading and leveling the liquid into a thin, consistent layer to form the non-digitally printed layer 530. Excess materials are scraped off by the rod 1606 to provide a uniform thickness to the non-digitally printed layer 530. Using the rod 1606 to apply the non-digitally printed layer 530 can ensure even application of the layer 530 with precise thickness control.

Both the layers 530 and 936 can be formed by a single pass application of the materials forming the layers 530, 936 using the Meyer rod 1606. That is, the layers 530, 936 can be formed as a single layer of the material. Alternatively, the Meyer rod 1606 (or different Meyer rods 1606) can be used in separate passes to separately form the layers 530, 936. After application of the layers 530, 936, the label assembly 1500 is completely formed.

At 1608, a portion 1610 of the label assembly 1500 is cut or separated from the remainder of the label assembly 1500 and rotated so that the carrier layer 1002 is on top (and farthest from the article 212) and the adhesive layer 936 is on bottom (and closest to the article 212). At 1612, the portion 1610 is applied to the article 212 so that the adhesive layer 936 contacts the article 212. At 1614, heat and pressure are applied to the portion 1610 of the label assembly 1500 through the carrier layer 1002 and the protective layer 1520. The heat and pressure can be applied by a heat transfer labeling machine 1618 (e.g., a cylindrical heat transfer label applicator), which applies the heat and pressure across all or a larger portion of the article 212 than just where the label 1506 is to be adhered to the article 212. This heat and pressure forms the chemical-physical interactions 1510 between the adhesive layer 936 and the article 212, and between the adhesive layer 936 and the protective layer 1520.

At 1616, the carrier layer 1002 and the portions of the protective layer 1520 that are not chemically bonded to the adhesive layer 936 (e.g., in locations where the adhesive layer 936 is not applied) are then removed, thereby forming an encapsulated label 1506 on the article 212. Using chemical-physical interactions 1510 to define where the protective layer 1520 tears and the label 1506 separates from the carrier layer 1002 allows for the heat and pressure to be applied across much larger areas than where the label 1506 is located. This can reduce the complexity of or eliminate the need for aligning the application of heat and pressure with the exact location of the label 1506 (as applying the heat and pressure outside of the location of the label 1506 does not result in unintentionally adhering extra portions of the label assembly 1500 outside of the label 1506 to the article 212). The shape of the label 1506 is defined by the outer boundaries of shapes formed by the chemical-physical interactions 1510 between the protective layer 1520 and the adhesive layer 936, as described above. This shape is defined and limited to the locations where the protective layer 1520 and the adhesive layer 936 overlap each other and chemically bond with each other (as well as the areas within or enclosed by these locations), regardless of other areas or locations where heat and pressure are applied. That is, if there is no chemical-physical interactions 1510 between the adhesive layer 936 and the protective layer 1520, and there is no chemical-physical interactions 1510 between the adhesive layer 936 and the protective layer 1520 in a boundary of a bounded area in the label assembly 1500, then that part of the label assembly 1500 will not separate from the label assembly 1500 as a label 1506. As a result, the adhesive layer 936 may not be present, be formed, or extend over an entirety of the label assembly 1500. Instead, the adhesive layer 936 may only be present in the label assembly 1500 in locations where the label 1506 is to be formed. The adhesive layer 936 may be selectively printed onto the backup layer 530 only in the areas where the label 1506 is to be formed to separate from the remainder of the label assembly 1500.

In the example shown in FIG. 15, the outer boundaries of each of the letters in the word “Indicia” represent the areas or locations where the adhesive layer 936 exists such that a chemical-physical interactions 1510 is formed between the protective layer 1520 and the adhesive layer 936 upon application of heat and pressure. The interior areas of each of these letters in the word “Indicia” represent the encapsulated portions of the layers 424, 530 between these chemical-physical interactions 1510 between the protective layer 1520 and the adhesive layer 936.

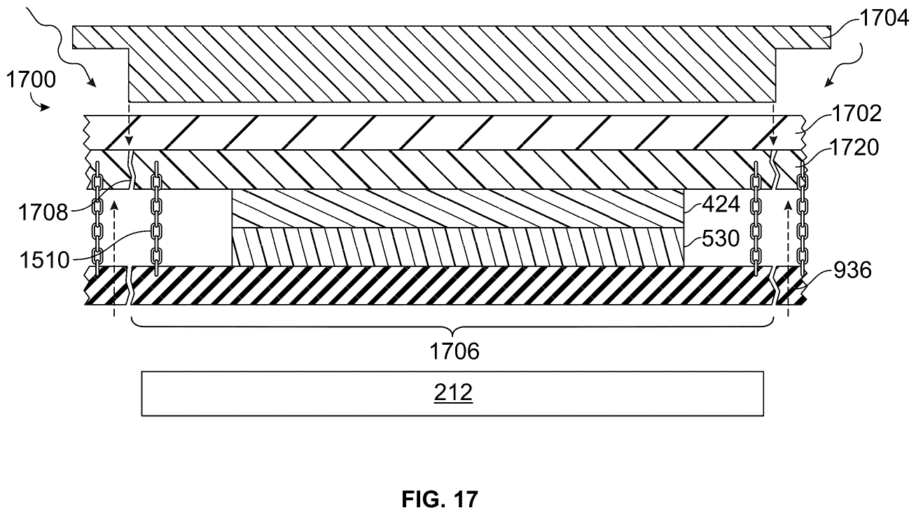

FIG. 17 illustrates another example of a hybrid heat transfer label assembly 1700. The label assembly 1700 can represent the label assembly 100 shown in FIGS. 1 and 2, and includes a multi-layered label 1706 that can represent the multi-layered label 106 shown in FIGS. 1 through 3. The label assembly 1700 includes an uncoated carrier layer 1702, a chemically incompatible coated protective layer 1720, the digitally printed graphics layer 424, the backer or backup layer 530, and the rubber adhesive layer 936.

The carrier layer 1702 can represent the carrier layer 102 in one example. The carrier layer 1702 can be formed from PET, such as a fifty-micron thick layer of PET. This type of carrier layer 1702 can provide a good balance of mechanical strength, stability, and release properties. The PET can withstand the high temperatures required for heat transfer without distorting or melting the carrier layer 1702. PET also ensures a smooth, controlled transfer of the label 1706 onto the article 212. This thickness of the PET carrier layer 1702 is sufficiently thin to keep the label assembly 1700 flexible, while being sufficiently thick to resist wrinkling or stretching.

The chemically incompatible coated protective layer 1720 can be non-digitally printed directly onto the carrier layer 1702. For example, no other materials or layers or coatings may be between the carrier layer 1702 and the protective layer 1720. The protective layer 1720 can be formed from materials that are chemically incompatible with the article 212 to which the label 1706 is applied. For example, the protective layer 1720 does not form a chemical-physical interactions 1510 with the article 212 or the surface of the article 212 when the label 1706 is applied to the article 212, regardless of whether heat and/or pressure are used to apply the label 1506 to the article 212. In one example, the protective layer 1720 can be non-digitally printed by forming the layer 1720 from acrylic that is coated onto the carrier layer 1702 using the Meyer rod 1606. As described herein, the protective layer 1720 can be printed onto or applied to all or substantially all (e.g., at least 95% of the surface area on one side) of the carrier layer 1702. As described herein, the application of heat and pressure by a heated die dictates where the protective layer 1720 tears to separate the label 1706 from the label assembly 1700. As a result, the protective layer 1720 can be applied to most, if not all, of one side of the carrier layer 1702.

The article 212 or the surface of the article 212 to which the label 1706 is applied can be formed from PVC or another polymer that does not form a chemical-physical interactions with the protective layer 1720. Alternatively, the article 212 or surface of the article 212 can be formed from steel, graphite, PET, polypropylene, ABS plastic, cotton, polyester, leather, or the like, which does not form chemical-physical interactions with the protective layer 1720.

The label assembly 1700 includes the digitally printed layer 424 on the protective layer 1720. The digitally printed layer 424 can be digitally printed using a toner or inkjet printer, as described above. The label assembly 1700 includes the backup or backer layer 530 that can be printed directly onto the digitally printed layer 424, as described above. The backup layer 530 can be chemically compatible with the article 212 or surface of the article 212 to which the label 1706 is applied. For example, the backup layer 530 can be formed from material(s) that chemically bond 1510 with the article 212. The backup layer 530 can be formed from solvent vinyl-based screen ink that is screen printed onto the digitally printed layer 424. The backup layer 530 can provide a solid color as a backup to the digitally printed layer 424, as described above. The solvent vinyl-based ink chemically bonds to a variety of substrates, including synthetic fabrics, plastics, and coated surfaces, which can increase the durability of the label 1706. This type of ink resists cracking, peeling, and fading over time, even with repeated washing, abrasion, and exposure to outdoor elements. Vinyl-based inks maintain flexibility, preventing the label 1706 from becoming stiff or brittle when applied to soft or stretchable fabrics like polyester or spandex blends. This type of ink also resists chemicals, solvents, and detergents, making the ink better for labels 1706 on garments that undergo harsh laundering or industrial cleaning.

The label assembly 1700 includes the adhesive layer 108 that can be printed (using a non-digital technique) onto the backup layer 530. The adhesive layer 108 can be referred to as a sizing layer and can be formed from material(s) that are chemically compatible with the article 212 or surface of the article 212 to which the label 1706 is applied. For example, the adhesive layer 108 can be formed from a solvent polyurethane-based ink (optionally with one or more crosslinking agents) that is screen printed on the backup layer 530. The adhesive layer 108 can enable the label 1706 to be adhered to a PVC surface of the article 212. One or more surfaces of the label assembly 1700 can be treated to change the energy of the surface(s), change the surface tension of the surface(s), or roughen the surfaces and thereby improve the adhesion of a layer to the treated surface, as described above. The chemically compatible adhesive layer 108 can be chemically compatible with the article 212 or the surface of the article 212 such that chemical-physical interactions 1510 form between the article 212 and the adhesive layer 108.

In one example, an optional tie layer is non-digitally printed on the backup layer 530 between the backup layer 530 and the adhesive layer 108. This tie layer can be formed from one or more solvent vinyl-based screen inks. The tie layer can assist in keeping the adhesive layer 108 bonded to the other layers in the label 1706. Alternatively, the backup layer 530 and the tie layer can be formed as a single layer.

In contrast to the label assembly 1500 and label 1506 shown and described in connection with FIGS. 15 and 16, the label 1706 separates from the label assembly 1500 (including the carrier 1702) in locations where a heated die 1704 contacts the label assembly 1700. The heated die 1704 represents a body, such as a metal body, which is heated to a temperature and pressed onto the carrier layer 108 to separate the label 1706 from the label assembly 1700 and apply the label 1706 to an article 212. The heat and pressure applied by the heated die 1704 forms the chemical-physical interactions 1510 between the protective layer 1702 and the adhesive layer 108. This causes the locations or areas where the die 1704 contacts the label assembly 1700 to be transferred as the label 1706, instead of the label assembly 1500 where the locations or areas where the adhesive 936 contacts the protective layer 1502 define the label 1506.

As schematically shown, the protective layer 1720 forms chemical-physical interactions 1510 with the adhesive layer 108 outside of the design layers (e.g., the digitally printed layer 424 and the backup layer 530 that provide the appearance or design of the label 1706). As shown, the chains representing the chemical-physical interactions 1510 do not extend to or into the carrier layer 1702. This indicates the lack or an absence of any chemical-physical interactions 1510 between the carrier layer 1702 and the protective layer 1720 (or between the carrier layer 1702 and any other layer 424, 530, 108).

The protective layer 1720 does not release from the carrier layer 1702 and does not tear or separate from itself without a chemical-physical interactions 1510. The protective layer 1720 is formed from materials that do not have any chemical compatibility to the article 212 to which the protective layer 1720 is applied. For example, an application surface 1704 of the adhesive layer 108 can be placed onto the article 212. Heat and pressure can be applied onto the label assembly 1700 on top of or through the carrier layer 1702 by the die 1704. The adhesive layer 108 chemically bonds with the article 212 or the surface of the article 212 to form the chemical-physical interactions 1510 between the adhesive layer 108 and the article 212. As a result, chemical-physical interactions 1510 exist between the protective layer 1720 and the adhesive layer 108 (and between the adhesive layer 108 and the article 212).

The tear through the protective layer 1720 can be in locations that correspond to interfaces between the adhesive layer 108 and the protective layer 1720. For example, the protective layer 1720 tears at the outer edges of the locations where the adhesive layer 108 contacts, overlaps, or chemically bonds to the protective layer 1720. Although not shown in FIG. 17, the adhesive layer 108 may extend upward in FIG. 17 on opposite sides of the layers 424, 530 and contact the protective layer 1720 (due to the label assembly 1700 being inverted from the perspective shown in FIG. 17 while the adhesive layer 108 is applied or printed). The outer lateral edges of the contact between the adhesive layer 108 and the protective layer 1720 are where the protective layer 1720 tears into different sections, with the section of the protective layer 1720 that overlaps, overlays, or contacts the adhesive layer 108 being removed from the carrier 1702 while other sections of the protective layer 1720 remain on the carrier layer 1702.

When the label assembly 1700 is heated in combination with pressure using the chemically compatible adhesive layer 108, the chemical-physical interactions 1510 between the protective layer 1720 and the adhesive layer 108 create a complete film encapsulation of the digital design layer 424 and non-digitally printed design layer (e.g., the layer 530). These design layers 424, 530 are completely sealed within and between (e.g., encapsulated) the protective layer 1720 and the adhesive layer 108, as described above.

The chemical-physical interactions 1510 between the adhesive layer 108 and the article 212 permanently bonds the label 1706 to the article 212. When the carrier layer 1702 is pulled from the article 212, these chemical-physical interactions 1510 create a perforation or separation 1708 around the design of indicia created by the layers 424, 530. For example, the chemical-physical interactions 1510 of the adhesive layer 108 to the protective layer 1720 and the chemical-physical interactions 1510 of the adhesive layer 108 to the article 212 causes the label 1706 to separate from the carrier layer 1702 and causes the protective layer 1720 to tear in locations indicated by the perforations 1708. The portions of the protective layer 1720, the digitally printed layer 424, the backup layer 530, and the adhesive layer 108 that are between these locations remain on the article 212 as the label 1706, while the remainder of these layers 1720, 424, 530, 108 and the entire carrier layer 1702 is removed from the article 212 (and the carrier layer 1702 is removed from the label 1706).

While the above description of the label 1706 mentions adhering the label 1706 to an article 212 (such as a PVC surface or a rubber surface of an article 212), other materials may be used. For example, the materials used to form the protective layer 1720 and the adhesive layer 108 can be changed and selected to be chemically dependent on the article 212. This provides for a clean breakaway of the label 1706 from the label assembly 1700.

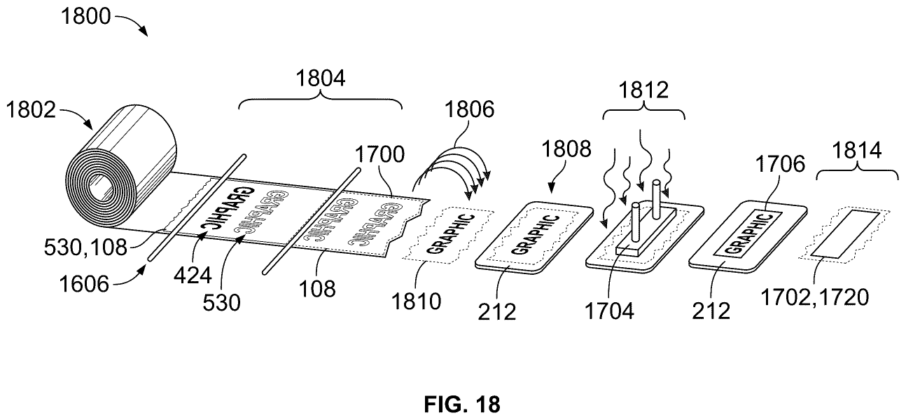

FIG. 18 illustrates one example of a method 1800 for constructing and/or applying the label 1706 shown in FIG. 17 to the article 212. For example, part of the method 1800 may include forming or manufacturing part of a hybrid heat transfer label assembly that includes a hybrid heat transfer label, and another part of the method 1800 may include applying the label from the assembly. Not all embodiments of the method 1800 are limited to only constructing, only applying, or both constructing and applying unless clearly and explicitly limited in that way. The article 212 is shown as a flat or planar body, but alternatively can have another shape. The method 1800 can include the protective layer 1720 being printed (in a non-digital or digital manner) onto the carrier layer 1702 using the Meyer rod 1606, and the digitally printed layer 424 being digitally printed onto the protective layer 1720. The carrier layer 1702, protective layer 1720, and the digitally printed layer 424 may be moved, stored, or otherwise handled on a roll or spool 1802. At 1804, the non-digitally printed backer layer 530 is printed onto the digitally printed layer 424 as the digitally printed layer 424, the protective layer 1720, and the carrier layer 1702 are unwound from the roll or spool 1802. The non-digitally printed backer layer 530 can be non-digitally printed or coated using a Meyer rod 1606.

At 1806, a portion 1810 of the label assembly 1700 is cut or separated from the remainder of the label assembly 1700 and rotated so that the carrier layer 1702 is on top (and farthest from the article 212) and the adhesive layer 108 is on bottom (and closest to the article 212). At 1808, the portion 1810 is applied to the article 212 so that the adhesive layer 108 contacts the article 212. At 1812, heat and pressure are applied to the portion 1810 of the label assembly 1700 through the carrier layer 1702 and the protective layer 1720. The heat and pressure can be applied by the heated die 1704 of the heat transfer labeling machine, which applies the heat and pressure across only the portion of the article 212 where the label 1706 is to be adhered to the article 212. This contrasts with the label assembly 1500 and the label 1506 shown and described in connection with FIGS. 15 and 16, where heat and pressure is applied over a larger area than just where the label 1506 is separated from the label assembly 1500 and adhered to the article 212. This heat and pressure forms the chemical-physical interactions 1510 between the adhesive layer 108 and the article 212, and between the adhesive layer 108 and the protective layer 1720.

At 1814, the carrier layer 1702 and the portions of the protective layer 1720 that are not chemically bonded to the adhesive layer 936 (e.g., in locations where the heat and pressure from the die 1704 are not applied) are then removed, thereby forming an encapsulated label 1706 on the article 212. Using the heat and pressure to form the chemical-physical interactions 1510 and define where the protective layer 1720 tears and the label 1706 separates from the carrier layer 1702 allows for the heat and pressure to define the shape and size of the label 1706.

One or more examples of the hybrid heat transfer label assemblies and hybrid heat transfer labels described herein optionally may include a protective stabilization layer to protect the digitally printed graphics layers in the assemblies and labels. As described and shown herein, the protective stabilization layer can be located between the digitally printed layer 424 and the rubber adhesive layer 936 (which may include or be separate from the adhesive layer 108). The stabilization layer may preserve and stabilize the inks forming the digitally printed layer 424 during application of heat and/or pressure onto the label assemblies (and particularly the rubber layer 936) by the heated dies 1704. The stabilization layer can be coated or non-digitally printed onto the digitally printed graphics layer 424 (e.g., using screen printing, using a Meyer rod, or another non-digital printing technique described herein). Alternatively, the stabilization layer can be digitally printed onto the graphics layer 424. The stabilization layer can be formed as a coating that completely covers the digitally printed layer from the same materials used to form the protective layer 1520. The stabilization layer can be clear or translucent, or may have a color or tint.

The stabilization layer protects and stabilizes the digitally printed inks forming the digitally printed layer 424 during vulcanization of the rubber layer 936, which occurs during application of the label to the article 212 (e.g., a rubber component or surface). As described herein, heat and pressure are applied to the label assembly to separate the label from the assembly and adhere the label to the article 212. This heat can vulcanize the rubber layer 936 to permanently bond the rubber layer 936 (and, therefore, the label) to the article 212. During vulcanization of the rubber layer 936, the rubber layer 936 can change phases or less viscous (or more fluid), and thereby less viscous due to the increased temperature. The rubber layer 936 then crosslinks and changes phases again to become solid. In the fluid state or phase, the rubber layer 936 can cause the inks forming the digitally printed layer 434 to run, bleed, or wash out. For example, contact between the fluid (or partially fluid) rubber layer 936 can cause these inks to spread beyond the intended boundaries of the inks into adjacent areas or differently colored inks (e.g., run or bleed). The inks also can lose intensity or be removed from the label (e.g., wash out). The inks can form drips or streaks, or create an unintended fuzzy or irregular appearance.

The stabilization layer can prevent the inks from running, bleeding, or washing out. This prevents the graphics formed by the inks from melting, distorting, degrading, or destroying the digital image or graphics. During vulcanization of the rubber layer 936, the inks in the layer 424 are prevented from contacting or being contacted by the fluid rubber in the rubber layer 936 by the stabilization layer. As a result, the inks in the layer 424 do not run, bleed, or become washed out from contact with the fluid rubber in the layer 936. The application of heat and pressure to the label creates a complete film encapsulation of the digitally printed layer 424, which fixes the position of the graphics or indicia in the layer 424 between the protective layer and the stabilization layer. During vulcanization of the rubber layer 936, the fluid or partially fluid rubber layer 936 cannot contact the inks in the graphics layer 424 and cannot cause these inks to run, bleed, or wash out. The protective layer and the stabilization layer can bond and melt (or partially melt) with each other during vulcanization to permanently bond the label to the article 212.

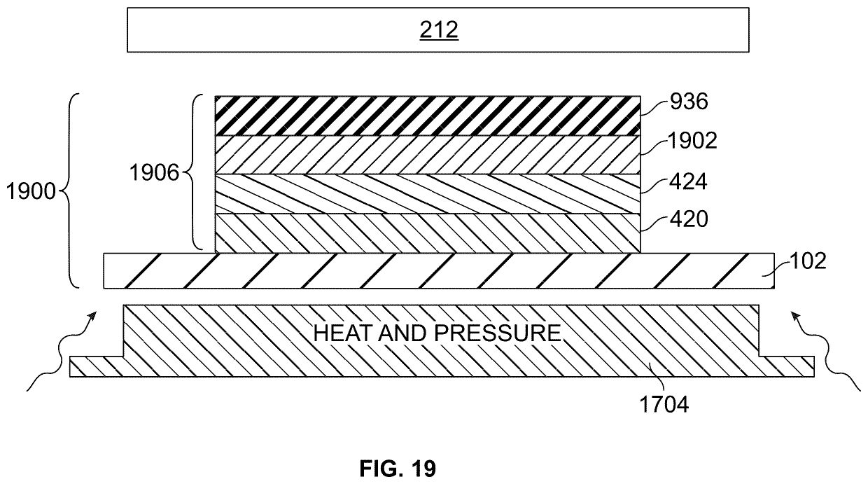

FIGS. 19 through 21 illustrate additional examples of hybrid heat transfer label assemblies 1900, 2000, 2100. These label assemblies 1900, 2000, 2100 can be variations of the label assembly 900 shown in FIG. 9, and include hybrid heat transfer labels 1906, 2006, 2106 that can be applied to articles 212 using the method 1600 shown and described in connection with FIG. 16. The label assembly 1900 in FIG. 19 includes the carrier sheet, layer, or film 102 and the protective coating or layer 420, similar to the label assembly 900. The carrier film 102 may be coated with a release coating, such as a silicone-based coating, to assist a hybrid heat transfer label 1906 from separating from the carrier film 102 and the label assembly 1900. Alternatively, the carrier film or layer 102 is not coated with any release coating.

The label assembly 1900 does not include the surface treatment layer 422, but optionally may include this layer 422. The label assembly 1900 includes the digitally printed graphics layer 424, which is on (e.g., digitally printed on top of) the protective layer or coating 420. The label assembly 1900 includes the rubber adhesive layer 936, which optionally can represent the adhesive layer 108 or a combination of the rubber layer 936 and the adhesive layer 108 for binding a hybrid heat transfer label 1906 from the label assembly 1900 to the article 212 upon application of heat and pressure from the heated die 1704 onto the carrier film 102, as described herein. The rubber layer 936 is formed from material(s) that is or are chemically compatible with the article 212. For example, the rubber layer 936 permanently bonds the label 1906 to the article 212 upon application of heat and pressure that vulcanizes the rubber layer 936. The rubber layer 936 may be a coating extending over the entirety of the label assembly 1900 and the labels 1906 contained therein.

The label assembly 1900 also includes a protective stabilization layer 1902 on (e.g., coated or non-digitally printed onto) the digitally printed graphics layer 424, with the rubber adhesive layer 936 on (e.g., coated or non-digitally printed onto) the stabilization layer 1902. The stabilization layer 1902 can be formed from the same material(s) as the protective layer 420. As described above, the stabilization layer 1902 protects the inks forming the digitally printed graphics layer 424 from melting, distorting, degrading, or destroying a digital image provided by the inks in the graphics layer 424. The stabilization layer 1902 can be translucent or have a dye or ink to provide a graphical color to the label 1906.

When the label assembly 1900 is heated in combination with pressure from the die 1704, the rubber layer 936 that is chemically compatible with the article 212 permanently bonds the label 1906 to the article 212. This creates a complete film encapsulation of the digital image in the graphics layer 424, thereby fixing the position of the digital graphics in the layer 424 between the protective layer 420 (or carrier film 102 in an example where no protective layer 420 is included in the label assembly 1900) and the stabilization layer 1902. The stabilization layer 1902 and the non-digitally printed (or coated) rubber compatible layer 936 bond and melt during vulcanization to permanently bond the label 1906 to the article 212. The spent carrier film 102 is removed after the vulcanization process is complete, and discarded.

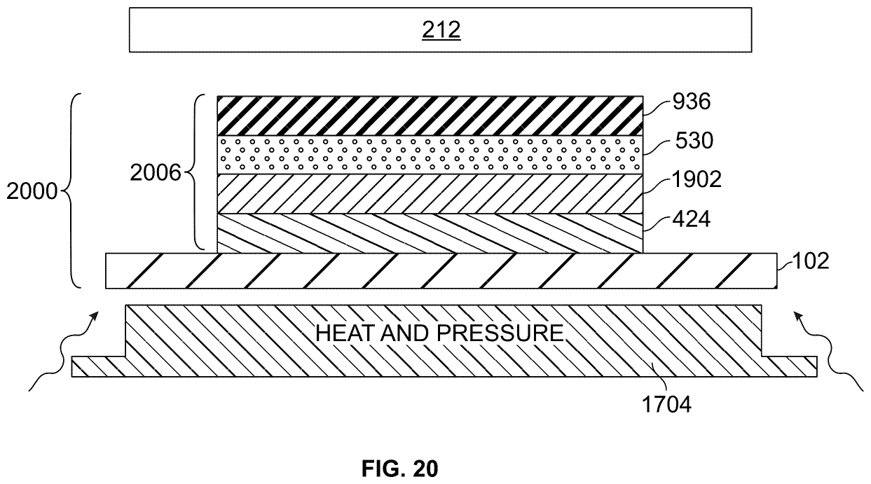

The label assembly 2000 in FIG. 20 differs from the label assembly 1900 shown in FIG. 19 in that the label assembly 2000 does not include the protective coating or layer 420 and includes the backup or backer layer 530. The backup/backer layer 530 can provide a background for the graphics layer 424 and/or help prevent visibility of the article 212 through the graphics layer 424. Alternatively, the backup or backer layer 530 may be replaced with the tie layer 426. In another example, the label assembly 2000 does not include the backup/backer layer 530 or the tie layer 426. A hybrid heat transfer label 2006 can be separated from the label assembly 2000 and the carrier film 102 and permanently bonded to the article 212 upon application of vulcanizing heat and pressure from the heated die 1704. As described above, the digitally printed graphics layer 424 is protected by the stabilization layer 1902 during this application of heat and pressure. The digitally printed layer 424 can include tougher polymer resins such as PET, polyolefin, epoxy, polyurethane, or acrylic to make the inks forming the layer 424 harder and more flexible. This can help the layer 424 strongly adhere to the stabilization layer 1902 and prevent the inks in the layer 424 from scratching. These inks are able to withstand abrasion, rubbing, or surface wear (when compared with inks that do not include the resins).

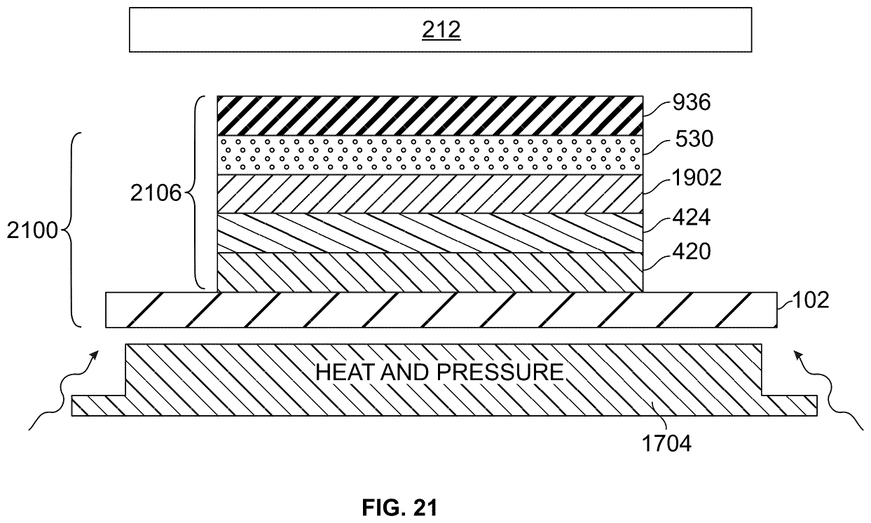

The label assembly 2100 in FIG. 21 differs from the label assembly 1900 shown in FIG. 19 in that the label assembly 2100 has the carrier film 102 with the release coating and the backer/backup layer 530. Alternatively, the label assembly 2100 may not include the release coating on the carrier film 102. In another example, the backup/backer layer 530 may be replaced with the tie layer 426. A hybrid heat transfer label 2106 can be separated from the label assembly 2100 and the carrier film 102 and permanently bonded to the article 212 upon application of vulcanizing heat and pressure from the heated die 1704. As described above, the digitally printed graphics layer 424 is protected by the stabilization layer 1902 during this application of heat and pressure.

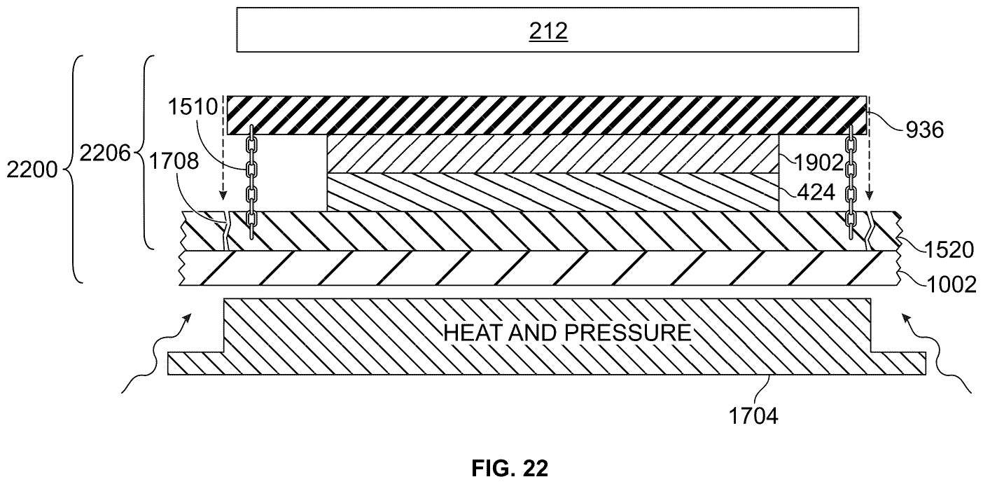

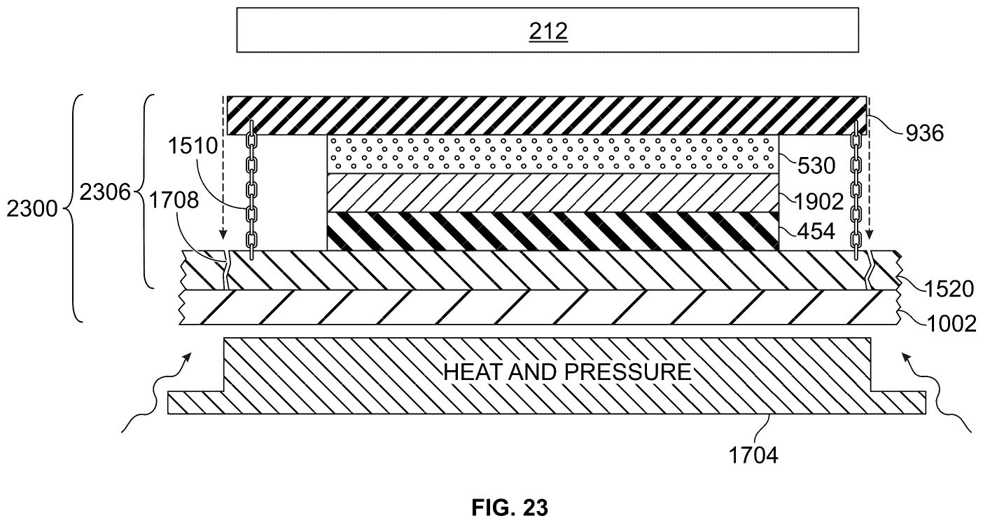

FIGS. 22 and 23 illustrate additional examples of hybrid heat transfer label assemblies 2200, 2300. These label assemblies 2200, 2300 can be variations of the label assembly 1500 shown in FIG. 15, and include hybrid heat transfer labels 2206, 2306 that can be applied to articles 212 using the method 1600 shown and described in connection with FIG. 16. The label assembly 2200 in FIG. 22 includes the carrier sheet, layer, or film 1002, the protective coating or layer 1520, the digitally printed graphics layer 424, and the adhesive/rubber layer 936 described herein. Optionally, the carrier film 1002 may include a release coating.

The label assembly 2200 does not include the backup/backer layer 530 that is in the label assembly 1500 and label 1506. The label assembly 2200 also includes the protective stabilization layer 1902 on (e.g., coated or non-digitally printed onto) the graphics layer 424, with the rubber adhesive layer 936 on (e.g., coated or non-digitally printed onto) the stabilization layer 1902. As described above, the stabilization layer 1902 protects the inks forming the graphics layer 424 from melting, distorting, degrading, or destroying a digital image provided by the inks in the graphics layer 424. The stabilization layer 1902 can be translucent or have a dye or ink to provide a graphical color to the label 2206.

As described above, the protective coating 1520 is not compatible with the article 212 (and does not form chemical-physical interactions 1510 or bonds with the article 212), whereas the adhesive/rubber layer 936 is chemically compatible with the article 212. As a result, the interactions 1510 form a permanent bond between the adhesive/rubber layer 936 and the protective layer 1520, which encapsulates the layers 424, 1902 between the adhesive/rubber layer 936 and the protective layer 1520 and forms perforations or separations 1708 for separating the label 2206, as described above.

The label assembly 2300 in FIG. 23 includes the carrier sheet, layer, or film 1002, but which includes a release coating in one example. The label assembly 2300 also includes the protective layer 1520, the digitally printed graphics layer 454, the stabilization layer 1902, and the adhesive/rubber layer 936. In contrast to the label assembly 2200 shown in FIG. 22, the label assembly 2300 may include the backup/backer layer 530 between the stabilization layer 1902 and the adhesive/rubber layer 936.

As described above, the protective coating 1520 is not compatible with the article 212 (and does not form chemical-physical interactions 1510 or bonds with the article 212), whereas the adhesive/rubber layer 936 is chemically compatible with the article 212. As a result, the interactions 1510 form a permanent bond between the adhesive/rubber layer 936 and the protective layer 1520, which encapsulates the layers 424, 1902, 530 between the adhesive/rubber layer 936 and the protective layer 1520 and forms perforations or separations 1708 for separating the label 2306, as described above.

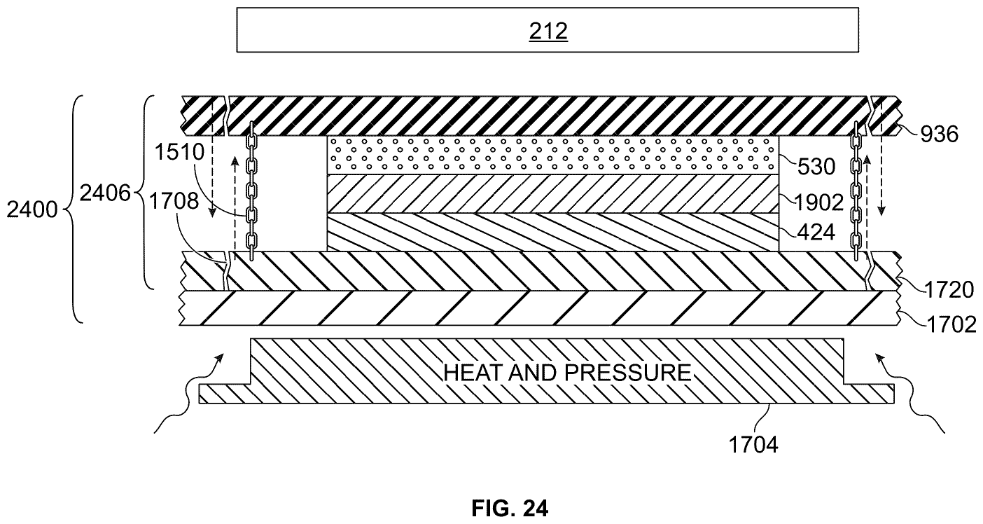

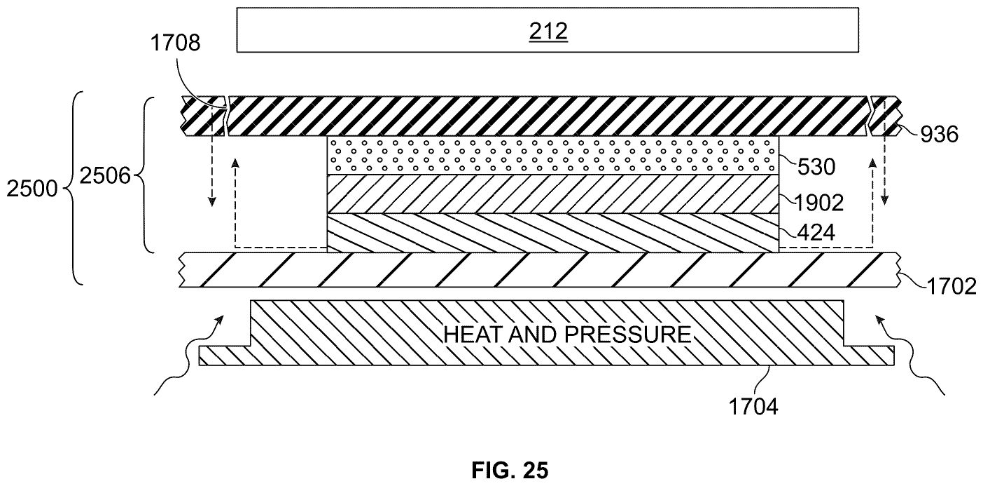

FIGS. 24 and 25 illustrate additional examples of hybrid heat transfer label assemblies 2400, 2500. These label assemblies 2400, 2500 can be variations of the label assembly 1700 shown in FIG. 17, and include hybrid heat transfer labels 2406, 2506 that can be applied to articles 212 using the method 1800 shown and described in connection with FIG. 18. The label assembly 2400 in FIG. 24 includes the carrier sheet, layer, or film 1702, the protective coating or layer 1720, the digitally printed graphics layer 424, the backer/backup layer 530, and the adhesive/rubber layer 936 described herein. Optionally, the carrier film 1702 may include a release coating.

The label assembly 2400 also includes the protective stabilization layer 1902 on (e.g., coated or non-digitally printed onto) the graphics layer 424, with the backer/backup layer 530 on (e.g., coated or non-digitally printed onto) the stabilization layer 1902. As described above, the stabilization layer 1902 protects the inks forming the graphics layer 424 from melting, distorting, degrading, or destroying a digital image provided by the inks in the graphics layer 424. The stabilization layer 1902 can be translucent or have a dye or ink to provide a graphical color to the label 2406.

As described above, the protective coating 1720 is not compatible with the article 212 (and does not form chemical-physical interactions 1510 or bonds with the article 212), whereas the adhesive/rubber layer 936 is chemically compatible with the article 212. The interactions 1510 form a permanent bond between the adhesive/rubber layer 936 and the protective layer 1720, which encapsulates the layers 424, 1902, 530 between the adhesive/rubber layer 936 and the protective layer 1720 and forms perforations or separations 1708 for separating the label 2406, as described above.

The label assembly 2500 in FIG. 25 includes the carrier sheet, layer, or film 1702, the digitally printed graphics layer 424, the stabilization layer 1902, the backer/backup layer 530, and the adhesive/rubber layer 936 described herein. The carrier film 1702 may include a release coating. Alternatively, the carrier film 1702 does not include the release coating. The label assembly 2500 does not include the protective coating or layer 1702 in one example. The digitally printed layer 424 can include tougher polymer resins such as PET, polyolefin, epoxy, polyurethane, or acrylic to make the inks forming the layer 424 harder and more flexible. This can help the layer 424 strongly adhere to the stabilization layer 1902 and prevent the inks in the layer 424 from scratching. These inks are able to withstand abrasion, rubbing, or surface wear (when compared with inks that do not include the resins).

The non-digitally printed layers described herein can be coated, or applied as coatings, rather than printed. For example, instead of using a printing pad or plate to transfer the materials used to form a non-digitally printed layer, the non-digitally printed layer can be applied as a coating using a Meyer bar, using blade or roll coating (e.g., as a flood coating), and can be referred to as a coating instead of a printed layer. Alternatively, the non-digitally printed layers can be printed using pad printing, gravure printing, flexographic printing, screen printing, offset printing, or the like.

The singular forms “a,” “an,” and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the embodiments, including the best mode, and to enable a person of ordinary skill in the art to practice the embodiments, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A method for applying a hybrid heat transfer label to a fabric article from a hybrid heat transfer label assembly, the method comprising:
digitally printing a graphics layer onto a non-digitally printed protective layer;
non-digitally printing a backer layer onto the graphics layer; and
printing an adhesive onto the backer layer, the adhesive and the protective layer printed to overlap such that the adhesive bonds with the protective layer bond via chemical-physical interactions upon application of heat and pressure to the protective layer, the adhesive printed to bond with the protective layer using the chemical-physical interactions such that the protective layer tears and separates the hybrid heat transfer label from a remainder of the hybrid heat transfer label assembly in areas where the adhesive and the protective layer overlap each other to apply the hybrid heat transfer label to the fabric article.

2. The method of claim 1, further comprising:
non-digitally printing the protective layer onto a carrier layer, wherein the adhesive and the protective layer are printed to overlap such that the adhesive bonds with the protective layer via the chemical-physical interactions upon application of heat and pressure to the protective layer, the adhesive and the protective layer printed to bond with each other using the chemical-physical interactions such that the protective layer tears and separates the hybrid heat transfer label from the remainder of the hybrid heat transfer label assembly in the areas where the adhesive and the protective layer overlap each other to apply the hybrid heat transfer label to the fabric article.

3. The method of claim 1, wherein the fabric article is a medical fabric.

4. The method of claim 1, wherein the adhesive is printed only in areas of the graphics layer where the protective layer, the graphics layer, and the backer layer are removed from the hybrid heat transfer label assembly to form the hybrid heat transfer label.

5. The method of claim 1, further comprising:
encapsulating the graphics layer and the backer layer between the adhesive and the protective layer by applying heat and pressure to the protective layer.

6. The method of claim 1, wherein the protective layer that is printed is chemically incompatible with the article, and the protective layer that is printed is chemically compatible with the adhesive that is printed.

7. The method of claim 1, wherein the adhesive is chemically compatible with the fabric article.

8. A method for applying a hybrid heat transfer label to a fabric article from a hybrid heat transfer label assembly, the method comprising:
digitally printing a graphics layer onto a non-digitally printed protective layer;
non-digitally printing a backer layer onto the graphics layer;
printing an adhesive onto the backer layer; and
bonding the adhesive to the protective layer using chemical-physical interactions and applying the hybrid heat transfer label to the fabric article by applying heat and pressure with a heated die.

9. The method of claim 8, further comprising:
non-digitally printing the protective layer onto a carrier layer, wherein the protective layer tears and separates the hybrid heat transfer label from the carrier layer and a remainder of the hybrid heat transfer label assembly in areas where the adhesive and the protective layer overlap each other.

10. The method of claim 9, wherein the protective layer that is printed is chemically incompatible with the article.

11. The method of claim 8, wherein the fabric article is a medical fabric.

12. The method of claim 8, wherein the adhesive is printed only in areas of the graphics layer where the protective layer, the graphics layer, and the backer layer are removed from the hybrid heat transfer label assembly to form the hybrid heat transfer label.

13. The method of claim 8, further comprising:
encapsulating the graphics layer and the backer layer between the adhesive and the protective layer.

14. A hybrid heat transfer label assembly comprising:
a non-digitally printed protective layer;
a digitally printed layer; and
a non-digitally printed second layer disposed with the digitally printed layer between the non-digitally printed protective layer and the non-digitally printed second layer, wherein the non-digitally printed protective layer, the digitally printed layer, and the non-digitally printed second layer form a hybrid heat transfer label that is configured to adhere to a fabric article upon application of heat.

15. The hybrid heat transfer label assembly of claim 14, further comprising:
a carrier layer with the protective layer between the carrier layer and the digitally printed layer.

16. The hybrid heat transfer label assembly of claim 14, wherein the fabric article is a medical fabric.

17. The hybrid heat transfer label assembly of claim 14, wherein the digitally printed layer is visible through the non-digitally printed protective layer once the label is adhered to the article.

18. The hybrid heat transfer label assembly of claim 14, wherein the non-digitally printed second layer includes an adhesive.

19. The hybrid heat transfer label assembly of claim 14, wherein the non-digitally printed second layer includes a tie layer.

20. The hybrid heat transfer label assembly of claim 14, wherein the non-digitally printed second layer includes a screen printed graphic layer.
